(19) United States
(12) Patent Application Publication
(10) Pub. No.: US 2017/0300053 A1
(43) Pub. Date: Oct. 19, 2017

(54) SELF-DRIVING VEHICLE SYSTEMS AND METHODS

(71) Applicants: Eric John Wengreen, Sammamish, WA (US); Wesley Edward Schwie, Bala Cynwyd, PA (US)

(72) Inventors: Eric John Wengreen, Sammamish, WA (US); Wesley Edward Schwie, Bala Cynwyd, PA (US)

(21) Appl. No.: 15/248,910

(22) Filed: Aug. 26, 2016

Related U.S. Application Data
(63) Continuation-in-part of application No. 15/099,565, filed on Apr. 14, 2016, now Pat. No. 9,429,947.

(51) Int. Cl. G05D 1/00; G06Q 20/14; H04R 3/00; H04L 29/08; G10L 25/78; G06K 9/00; H04N 5/225

(52) U.S. Cl. CPC G05D 1/0088; H04R 3/005; G06Q 20/145; G06K 9/00087; G10L 25/78; G06K 9/00288; H04N 5/225; H04R 2499/13; H04L 67/12

(57) ABSTRACT

When a human driver picks up a passenger, the driver typically looks at the passenger to determine if the passenger is the individual who is supposed to receive a ride. Self-driving vehicles often do not have a human in the vehicle to make this decision. Several systems and methods described herein enable self-driving vehicles to know if they are picking up the correct person.

### CROSS-REFERENCE TO RELATED APPLICATION

The entire contents of the following application are incorporated by reference herein: U.S. patent application Ser. No. 15/099,565; filed Apr. 14, 2016; and entitled SELF-DRIVING VEHICLE SYSTEMS AND METHODS.

### BACKGROUND

### Field

Various embodiments disclosed herein relate to vehicles. Certain embodiments relate to self-driving motorized vehicles.

### Description of Related Art

Vehicles typically require a driver. The driver is tasked with keeping the vehicle safely on the road while avoiding obstacles. Driver-caused errors cost tens of thousands of lives per year. Self-driving vehicles have the potential to eliminate driver error, and thereby save tens of thousands of lives every year. Although self-driving vehicles excel under “normal” driving conditions, they struggle with the often unpredictable nature of life. As a result, there is a need for systems and methods that enable self-driving vehicles to cope with non-standard events.

### SUMMARY

Self-driving vehicles will save tens of thousands of lives per year. The majority of vehicle-related deaths are caused by driver errors. Tests have shown that self-driving vehicles nearly eliminate self-inflicted accidents (although they are not immune to accidents caused by human drivers of other vehicles). Self-driving vehicles have unlimited attention spans and can process complex sensor data nearly instantaneously. The ability of self-driving vehicles to save lives is so impressive that society has a moral imperative to develop self-driving technology such that it can be widely adopted.

Self-driving vehicles, however, have shortcomings. Although self-driving vehicles excel under “normal” driving conditions, they sometimes struggle with new situations that often would not be overly difficult for a human. Some of the embodiments described herein enable a hybrid approach that leverages the exceptional abilities of self-driving vehicles while soliciting human interaction in select situations. The resulting combination of machine intelligence and human intelligence significantly enlarges the potential of self-driving vehicles in a manner that will enable self-driving vehicles to become widespread much faster than would otherwise be the case.

In some embodiments (i.e., optional and independently combinable with any of the aspects and embodiments identified herein), a method of using a self-driving vehicle comprises identifying, by the vehicle, a need for a human interaction; sending, by the vehicle (e.g., directly or indirectly) in response to identifying the need, a first wireless communication to a remote computing device; and/or receiving, by the vehicle, the human interaction in response to the first wireless communication. Various embodiments include diverse needs for human interaction and types of human interactions.

In several embodiments (i.e., optional and independently combinable with any of the aspects and embodiments identified herein), the human interaction can be from a remotely located human (e.g., not located inside the vehicle) or from a human located inside the vehicle (e.g., from a person who was not actively steering the vehicle at the time the vehicle identified the need for human interaction).

In some embodiments, a method of using a self-driving vehicle comprises identifying, by the vehicle, a need for a human interaction; notifying, by the vehicle in response to identifying the need, a human regarding the need; and/or receiving, by the vehicle, the human interaction in response to the notifying.

In embodiments that include elements such as sending, by the vehicle, a first wireless communication to a remote computing device, the vehicle can do these elements of claimed methods by using the vehicle plus by using intermediary communication systems such as wireless networks, cellular networks, telephone networks, Internet systems, servers, cloud computing, remotely located computers, satellite systems, communication systems, and any other suitable means of enabling the vehicle to send communications to a remote computing device. Thus, while the vehicle is used to send wireless communications to the remote computing device, as used herein, the vehicle can use intermediary communication systems to perform claimed method elements. For example, the vehicle may send wireless communications to the remote computing device and/or receive wireless communications from the remote computing device via intermediary communication systems, which can serve as a communication bridge between the vehicle and the remote computing device.

In many embodiments, the vehicle can perform any of the elements autonomously (e.g., without a person located in the car performing the elements even if the car is transporting a passenger).

In some embodiments, identifying the need (for human interaction) comprises detecting, by the vehicle, a person located outside of the vehicle and located within 6 feet of a driver's side window of the vehicle. Detecting by the vehicle can comprise detecting by at least one of a video camera, a microphone system, a proximity sensor, an infrared sensor, a radar detector, and a motion sensor of the vehicle.

In several embodiments, identifying the need (for human interaction) comprises detecting, by the vehicle, a knock on a portion of the vehicle. Detecting by the vehicle can comprise detecting at least one of a sound by a microphone system (of the vehicle) and a vibration by a vibration sensor (of the vehicle). The sound and the vibration can be indicative of a person knocking on the vehicle (e.g., knocking on an exterior of the vehicle, knocking on a glass window of the vehicle, knocking on sheet metal of the vehicle).

In some embodiments, identifying the need (for human interaction) comprises detecting, by a microphone system of the vehicle, an audible voice and determining, by the vehicle, that the audible voice originated from outside the vehicle. Receiving remote human interaction can comprise receiving audio data recorded by a microphone of the remote computing device. The vehicle can comprise a speaker arranged and configured to emit sound outside the vehicle to enable a person located outside the vehicle to hear the sound. Embodiments can also comprise emitting outside the vehicle, by the speaker of the vehicle, the sound based on the audio data; recording, by the microphone system of the vehicle, a verbal response to the sound from the person located outside the vehicle; and/or sending automatically, by the vehicle, a recording of the verbal response to the remote computing device.

In several embodiments, the vehicle further comprises a display screen facing outward such that the person located outside the vehicle can see information on the display screen. Receiving the remote human interaction can comprise receiving a video recorded by a video camera of the remote computing device. Embodiments can comprise showing the video on the display screen facing outward such that the vehicle is configured to enable the person located outside the vehicle to see the video.

In several embodiments, identifying the need (for human interaction) comprises detecting, by a microphone system of the vehicle, an audible voice, and determining, by the vehicle, that the audible voice is greater than a threshold configured to help the vehicle differentiate between background voices and voices directed to the vehicle from a location outside of the vehicle.

In some embodiments, identifying the need (for human interaction) comprises detecting, by a microphone system of the vehicle, an audible voice of a person; determining, by the vehicle, at least one of the audible voice originated outside the vehicle and the person is located outside the vehicle; and/or determining, by the vehicle, that the voice has asked a question. In several embodiments, the vehicle determines that the voice has asked a question by analyzing the words spoken by the voice to identify a question and/or by determining that an intonation of the voice is indicative of a question.

In some embodiments, a microphone system of the vehicle comprises a first microphone and a second microphone spaced apart from the first microphone. Identifying the need (for human interaction) can comprise detecting, by the first and second microphones of the vehicle, an audible voice; comparing, by the vehicle, a first voice signal detected by the first microphone and a second voice signal detected by the second microphone to evaluate a directionality of the voice; and/or determining, by the vehicle, that the directionality is indicative of the voice being directed towards the vehicle.

In several embodiments, the vehicle comprises a speaker arranged and configured to emit a first sound outside the vehicle to enable a person located outside the vehicle to hear the first sound. The vehicle can comprise a first microphone arranged and configured to record a second sound emitted by the person located outside the vehicle. The vehicle can comprise a first video camera arranged and configured to record a first video of an area outside the vehicle. Receiving remote human interaction can comprise receiving audio data recorded by a second microphone of the remote computing device. Embodiments can comprise emitting outside the vehicle, by the speaker of the vehicle, the first sound based on the audio data; recording, by the first microphone of the vehicle, a verbal response from the person located outside the vehicle to the first sound; recording, by the first video camera, the first video of the area outside the vehicle during the verbal response; and/or sending, by the vehicle, the first video and a recording of the verbal response to the remote computing device.

In some embodiments, the vehicle further comprises a display screen facing outward such that the person located outside the vehicle can see information on the display screen. Receiving the remote human interaction can comprise receiving a second video recorded by a second video camera of the remote computing device. Embodiments can comprise showing the second video on the display screen facing outward such that the vehicle is configured to enable the person located outside the vehicle to see the second video.

In several embodiments, the vehicle comprises a video camera and a speaker arranged and configured to emit a first sound and a second sound outside the vehicle to enable a person located outside the vehicle to hear the first and second sounds. Embodiments can comprise initiating a three-way audio communication between the person located outside the vehicle, a first human representative of the vehicle, and a second human representative of the vehicle. The first human representative and the second human representative can be located remotely relative to the vehicle. The remote computing device can be a first remote computing device associated with the first human representative. The second remote computing device can be associated with the second human representative.

In some embodiments, three-way audio communication can comprise receiving, by the vehicle, a first audio data recorded by a microphone of the first remote computing device, and a second audio data recorded by a microphone of the second remote computing device; emitting outside the vehicle, by the speaker of the vehicle, the first sound based on the first audio data; emitting outside the vehicle, by the speaker of the vehicle, the second sound based on the second audio data; and/or recording, by a microphone system of the vehicle, a verbal response from the person located outside the vehicle, and sending a first recording of the verbal response to the first remote computing device and the second remote computing device.

Several embodiments (i.e., optional and independently combinable with any of the aspects and embodiments identified herein) comprise recording, by the microphone system of the vehicle, a verbal request from the person located outside the vehicle, and sending a second recording of the verbal request to the first remote computing device and the second remote computing device. Emitting outside the vehicle, by the speaker of the vehicle, the first sound based on the first audio data can occur in response to the verbal request comprising a first request. Emitting outside the vehicle, by the speaker of the vehicle, the second sound based on the second audio data can occur in response to the verbal request comprising a second request.

In several embodiments, the vehicle comprises a video camera and a speaker arranged and configured to emit sound outside the vehicle to enable a person located outside the vehicle to hear the sound. Identifying the need (for human interaction) can comprise detecting, by the vehicle, a collision of the vehicle. The first wireless communication can comprise a notification regarding the collision and a video of the collision taken by the video camera of the vehicle.

Some embodiments (i.e., optional and independently combinable with any of the aspects and embodiments identified herein) comprise initiating, in response to the detecting the collision, a two-way audio communication between the person located outside the vehicle and a human representative of the vehicle while the human representative is located remotely relative to the vehicle. The two-way audio communication can comprise receiving, by the vehicle, audio data recorded by a microphone of the remote computing device; emitting outside the vehicle, by the speaker of the vehicle, the sound based on the audio data; recording, by a microphone system of the vehicle, a verbal response to the sound from the person located outside the vehicle; and/or sending a recording of the verbal response to the remote computing device.

In several embodiments, identifying the need (for human interaction) comprises at least one of approaching a destination, being within two minutes of arriving at the destination, and arriving at the destination. In response to the identifying the need, some embodiments comprise contacting a representative of the vehicle via the remote computing device and/or prompting the representative to communicate with a person who is at least one of at the destination and representing the destination (e.g., while the representative of the vehicle is located remotely relative to the destination). The person representing the destination can be located at the destination or located remotely relative to the destination. For example, the person representing the destination can be located at a call center that is in a different location than the destination.

In some embodiments, identifying the need (for human interaction) comprises at least one of being within two minutes of arriving at a destination and arriving at the destination. Embodiments can comprise prompting a person at the destination to at least one of load an inanimate object into the vehicle and unload the inanimate object from the vehicle.

In several embodiments, the identifying the need (for human interaction) comprises at least one of approaching a fuel station, being within two minutes of arriving at the fuel station, and arriving at the fuel station. As used herein, a “fuel station” is configured to provide at least one of electricity, hydrogen, natural gas, diesel, petroleum-derived liquids, and/or any other substance suitable to provide energy to enable vehicles to move.

In some embodiments, identifying the need (for human interaction) comprises at least one of approaching a payment station of a parking garage, being within two minutes of arriving at the payment station, and arriving at the payment station. Embodiments can comprise initiating a two-way audio communication between an attendant of the parking garage and a human representative of the vehicle while the human representative is located remotely relative to the vehicle. Embodiments can comprise initiating the two-way audio communication in response to identifying the need for the remote human interaction.

In some embodiments, identifying the need for remote human interaction comprises determining, by the vehicle, that a person is not located in the vehicle. The vehicle can determine that a person is not located in the vehicle using infrared sensors, motion sensors, and/or video cameras.

In several embodiments, identifying the need (for human interaction) comprises detecting, by a sensor of the vehicle, a condition of a road and/or of a road surface, and determining that the condition is potentially hazardous to the vehicle. For example, the road might be blocked, be too narrow, have insufficient overhead clearance, and/or be incomplete. For example, the road surface may be snowy, icy, overly bumpy, have hazardous potholes, and/or have loose gravel. Receiving human interaction can comprise receiving, by the vehicle, an instruction based on input from a human (e.g., who can be located remotely relative to the vehicle). The input can be in response to the condition. The instruction can comprise information regarding how the vehicle should respond to the condition of the road surface.

Instructions can comprise general driving behavior modifications to be applied over an extended period of time (rather than instantaneous modifications such as “turn left 5 degrees right now.”) In several embodiments, the general driving behavior modifications apply to vehicle driving over a period of at least sixty seconds and often for at least five minutes.

In some embodiments, identifying the need (for human interaction) comprises identifying, by the vehicle, a discrepancy between an actual road and a road map (e.g., accessible to the vehicle and/or referenced by the vehicle). Receiving the human interaction can comprise receiving, by the vehicle in response to the first wireless communication, an instruction regarding how the vehicle should respond to the discrepancy. The instruction can include the selection of an alternate route.

In several embodiments, identifying the need for the human interaction comprises identifying, by the vehicle, an impasse due to at least one of road conditions and traffic conditions. In several embodiments, identifying the need for the human interaction comprises identifying, by the vehicle, adverse traffic conditions (e.g., that would cause the vehicle to travel at least 35 percent under the road's speed limit). Receiving the remote human interaction can comprise receiving, by the vehicle in response to the first wireless communication, an instruction regarding how the vehicle should respond to the impasse. The instruction can include the selection of an alternate route.

In some embodiments, identifying the need (for human interaction) comprises determining that the vehicle is at least one of within a distance threshold of a potential rider and within a time threshold of arriving at a location of the potential rider.

Several embodiments comprise recording, by a microphone system of the vehicle, a sound emitted by the potential rider; sending a recording of the sound to the remote computing device; and then receiving authorization for the vehicle to transport the potential rider in response to a human hearing the sound via the remote computing device and then authorizing, by the remote computing device, the vehicle to transport the potential rider.

Some embodiments comprise recording, by a camera of the vehicle, a picture showing the potential rider; sending the picture to the remote computing device; and then receiving authorization for the vehicle to transport the potential rider in response to a human seeing the picture and then authorizing, by the remote computing device, the vehicle to transport the potential rider.

In several embodiments, methods of using a self-driving vehicle comprise identifying, by a vehicle management system, a need for a remote human interaction in response to receiving a transportation request from a potential rider; sending, by the vehicle management system in response to identifying the need, a first wireless communication to a remote computing device; and/or receiving, by the vehicle management system, the remote human interaction in response to the first wireless communication.

In some embodiments, the first wireless communication comprises at least one identity indicator of the potential rider. Receiving the remote human interaction can comprise receiving authorization for the vehicle to transport the potential rider in response to a human representative of the vehicle receiving the identity indicator and then authorizing, by the remote computing device, the vehicle to transport the potential rider. The human representative can authorize the vehicle to transport the potential rider in response to receiving, analyzing, verifying, and/or seeing the identity indicator.

In several embodiments, the vehicle comprises a speaker and a microphone system. Embodiments can comprise initiating a two-way audio communication between the potential rider and the human representative in response to at least one of the first wireless communication and the potential rider entering the vehicle.

In some embodiments, the vehicle comprises a camera. Embodiments can comprise taking a picture, by the camera, of the potential rider. The identity indicator can comprise the picture. Embodiments can comprise sending the picture to the remote computing device.

In several embodiments, the vehicle comprises a microphone system. Embodiments can comprise recording, by the microphone system, an audible voice of the potential rider. The identity indicator comprises a recording of the audible voice. Embodiments can comprise sending the recording to the remote computing device.

In some embodiments, methods of using a self-driving vehicle comprise receiving, by a vehicle management system, a first identity indicator of a prospective rider; detecting, by the vehicle, a second identity indicator of a person; and/or sending, by the vehicle, the second identity indicator to the vehicle management system.

In several embodiments, the vehicle management system can receive the first identity indicator of the prospective rider requesting the ride. The prospective rider can request a ride by using application software (e.g., an “app”) on her smartphone. Then, in response to the ride request, the vehicle management system can receive the first identity indicator of the prospective rider. The first identity indicator can be a name, a username, a code, a picture, a fingerprint, and/or any suitable means of representing an identity of the prospective rider. The vehicle management system can receive the first identity indicator when the prospective rider is at least 500 feet away from the vehicle (e.g., prior to the vehicle pulling up to pick up the rider). The vehicle management system can receive the first identity indicator prior to the vehicle detecting the second identity indicator of the person.

In some embodiments, methods include receiving, by the vehicle management system, a first identity indicator of the prospective rider in response to the prospective rider requesting a ride from a ride providing service with many vehicles. The prospective rider can request the ride with or without knowing which specific vehicle will provide the ride. Then, methods can include detecting, by the vehicle, the second identity indicator of the person once the vehicle that will provide that ride is within a direct detection range of the person. In some embodiments, the person is detected by detecting an electronic device in the possession of the person. The identity of the prospective rider can be checked when the prospective rider requests the ride. The identity of the person can be checked as the vehicle approaches the person to provide the ride, when the vehicle is within a direct detection range of the person, as the person attempts to enter the vehicle, when the person is inside the vehicle prior to starting to provide the ride, and/or when the person is inside the vehicle during the ride (e.g., as the vehicle is moving towards the person's destination).

In several embodiments, the vehicle can detect the second identity indicator of the person in response to the prospective rider requesting a ride. For example, requesting the ride can start a chain of events that results in a vehicle being sent (e.g., by the vehicle management system, by a management system) to the rider. Then, the vehicle can detect the second identity indicator of the person.

Some embodiments comprise determining, by the vehicle management system, that the first and second identity indicators are indicative of the person being the prospective rider. For example, the first identity indicator can be a name associated with a user account. The second identity indicator can be data (e.g., a code) send from a remote computing device (e.g., a computer, a smartphone) of the person to the vehicle. The system can determine if the data is also associated with the same user account. In some embodiments, the first and second indicators match. In several embodiments, the first and second indicators are different, but are both associated with the prospective rider such that by detecting the second identity indicator, the system knows that the person is the prospective rider.

Several embodiments comprise providing, by the vehicle, a ride to the person, and, in response to the determining, billing a user account of the prospective rider for the ride. The user account can have credit card information, PayPal information, online payment information, and/or other information configured to enable billing the prospective rider for the ride (e.g., such that a company that operates, directs, and/or controls the vehicle and/or the vehicle management system receives payment for the ride). The user account can comprise a name that represents the prospective rider, a mailing address of the prospective rider, an email address of the prospective rider, a phone number of the prospective rider, and/or any suitable information to help collect debts owed by the prospective rider for rides associated with the user account.

In some embodiments, methods of using a self-driving vehicle comprise receiving, by a vehicle management system, by a vehicle, by a combination of the vehicle management system and the vehicle, a first identity indicator of a prospective rider. Embodiments can comprise detecting, by the vehicle management system, by the vehicle, by a combination of the vehicle management system and the vehicle, a second identity indicator of a person. Embodiments can comprise sending, by the vehicle management system, by the vehicle, by a combination of the vehicle management system and the vehicle, the second identity indicator to the vehicle management system. Embodiments can comprise determining, by the vehicle management system, by the vehicle, by a combination of the vehicle management system and the vehicle, that the first and second identity indicators are indicative of the person being the prospective rider. Embodiments can comprise, in response to the determining, billing, by the vehicle management system, by the vehicle, by a combination of the vehicle management system and the vehicle, by a second system, a user account of the prospective rider for the ride.

Some embodiments comprise detecting the second identity indicator while the person is located within a direct detection range of the vehicle. For example, the vehicle can receive a wireless signal (e.g., via Bluetooth or another suitable short-range wireless communication protocol) from a remote computing device of the person. Rather than the wireless signal going from the remote computing device to the vehicle via a cellular network comprising antenna towers and other remote communication hardware, the wireless signal can go directly from the remote computing device to the vehicle (e.g., to an antenna of the vehicle). The direct detection range of a camera of the vehicle can be such that the camera is able to take a picture of the person. The direct detection range of a fingerprint scanner can be such that the scanner is able to scan the fingerprint of the person.

Several embodiments comprise receiving the first identity indicator in response to the vehicle detecting the second identity indicator. For example, the vehicle management system can receive the first identity indicator after the vehicle has received the second identity indicator. Once the vehicle has received the second identity indicator, the vehicle can request the first identity indicator to enable the vehicle to bill the appropriate user account.

Several embodiments comprise receiving the first identity indicator while the person is located outside of the direct detection range (e.g., prior to the vehicle approaching the person and/or arriving at a pickup location).

In some embodiments, the second identity indicator is identification data. Identification data can be received indirectly by the vehicle from a remote computing device. For example, the wireless communication that comprises the identification data can travel from the remote computing device via cellular networks and/or the Internet to the vehicle. Identification data can be received via a direct wireless communication from a remote computing device to the vehicle (e.g., via Bluetooth or another short-range wireless communication protocol). Detecting the second identity indicator can comprise receiving, by the vehicle, the identification data from a remote computing device of the person via a direct wireless communication from the remote computing device to the vehicle.

In several embodiments, the first identity indicator is identification data from a remote computing device of the prospective rider. For example, when the prospective rider creates her user account and/or requests a ride via an app, the remote computing device can capture identification data and/or a remote system can create identification data that is then associated with the remote computing device (to enable the system to recognize who is requesting a ride). Some embodiments comprise receiving, by the vehicle management system, the first identity indicator via an indirect wireless communication.

In some embodiments, the second identity indicator comprises a passcode entered by the person while the person is located within a direct detection range of the vehicle.

In several embodiments, the second identity indicator comprises a picture of the person. Detecting the second identity indicator can comprise taking, by a camera of the vehicle, the picture. The picture can be a video, a still picture, an infrared picture, and/or any visual representation of the person.

In some embodiments, the second identity indicator comprises a fingerprint of the person. Methods can comprise detecting, by the vehicle, the fingerprint. Methods can comprise receiving, by the vehicle, the fingerprint (e.g., via a fingerprint scanner of the vehicle or of a remote computing device).

In several embodiments, the second identity indicator comprises a sound emitted by the person. The sound can be words spoken by the person. Methods can comprise detecting, by the vehicle, the sound.

In some embodiments, the second identity indicator comprises a physical trait of the person. Methods can comprise detecting, by a biometric device of the vehicle, the physical trait.

Several embodiments comprise authorizing, by the vehicle management system and/or by the vehicle, the vehicle to provide a ride to the person in response to determining that the first and second identity indicators are indicative of the person being the prospective rider. The determining can occur while the person is at least one of waiting for the ride and located in the vehicle. Receiving the first identity indicator can occur prior to detecting the second identity indicator. Receiving the first identity indicator can occur prior to the prospective rider requesting a ride and/or prior to the person waiting for the ride.

In some embodiments, at least a portion of the vehicle management system is located in the vehicle. In several embodiments, at least a portion of the vehicle management system is located remotely relative to the vehicle. The vehicle management system can comprise many servers, computers, and vehicles. The vehicle management system can comprise cloud computing and cloud storage.

In several embodiments, the entire vehicle management system is located in the vehicle. The vehicle can comprise the vehicle management system.

In some embodiments, a first portion of the vehicle management system is physically coupled to the vehicle, and a second portion of the vehicle management system is not physically coupled to the vehicle. The second portion can be located remotely relative to the vehicle. In several embodiments, the entire vehicle management system is located remotely relative to the vehicle.

In several embodiments, the vehicle management system is located remotely relative to the vehicle. Methods can comprise sending, by the vehicle, a wireless communication having the second identity indicator, to the vehicle management system, and/or receiving, by the vehicle, authorization for the vehicle to provide a ride to the person in response to the sending and/or determining that the first and second identity indicators are indicative of the person being the prospective rider.

In some embodiments, the vehicle management system is physically coupled to the vehicle such that the vehicle is configured to transport the vehicle management system.

Several embodiments comprise automatically starting a call with a human representative of the vehicle and/or of the vehicle management system in response to the person entering the vehicle. The call can be configured to solicit information that the vehicle and/or the system needs from the person. The call can be configured to provide instructions to the person. For example, the call can be configured to instruct the person to exit the vehicle because the person is not the prospective rider.

In some embodiments, the vehicle comprises a speaker and a microphone system configured to enable two-way audio communication. Methods can comprise initiating, enabling, starting, facilitating, and/or prompting, in response to the person entering the vehicle, the two-way audio communication between the person and a human representative of the vehicle while the human representative is located remotely relative to the vehicle. The human representative can be an owner of the vehicle. The human representative can be an employee or contractor at a company hired to help manage rides provided by the vehicle, which might or might not be owned by the company.

Several embodiments comprise initiating, enabling, starting, facilitating, and/or prompting a two-way audio communication between the person and a human representative of the vehicle while the human representative is located remotely relative to the person and the vehicle in response to detecting, by the vehicle, at least one of the vehicle moving within a proximity range of the person, the person approaching the vehicle, the person entering the vehicle, and the person being located in the vehicle. The proximity range can be a detection range of the vehicle and/or a predetermined distance. In several embodiments, the proximity range is 30 feet.

In alternative embodiments, any step performed by the vehicle management system can be performed by the vehicle. In alternative embodiments, any step performed by the vehicle can be performed by the vehicle management system. The vehicle management system can be a part of the vehicle, can have a portion that is part of the vehicle, can have a portion that is not part of the vehicle, and/or can be physically completely separate from the vehicle. The vehicle management system can be communicatively coupled to the vehicle. The vehicle management system can communicate with the vehicle via wires and/or wirelessly.

In some cases, a prospective rider requests a ride, but the vehicle accidentally picks up the wrong person. As a result, the prospective rider might not receive the ride from the vehicle. The prospective rider will want to ensure she is not billed for a ride given to someone not associated with her user account. In some embodiments, a user account is associated with multiple people (e.g., a mother and her teenage child). The mother likely would not mind if she is billed for a ride given to her child. The mother, however, will not want to be billed for a ride accidentally given to a stranger.

Some embodiments comprise determining, by the vehicle management system, that the first and second identity indicators are not indicative of the person being the prospective rider. Methods can comprise initiating and/or prompting (in response to the determining) a two-way audio communication between the person and a human representative of the vehicle while the human representative is located remotely relative to the person and the vehicle. The human representative can be a manager of the vehicle, an owner of the vehicle, the prospective rider, and/or any suitable person.

Several embodiments comprise determining, by the vehicle management system, that the first and second identity indicators are not indicative of the person being the prospective rider, and instructing, in response to the determining, the person to exit the vehicle. The instructing can be via a sound emitted by a speaker of the vehicle and/or by a speaker of a remote computing device of the person. The sound can say, “You are not the intended rider. Please exit the vehicle.”

Some embodiments comprise determining, by the vehicle management system, that the first and second identity indicators are not indicative of the person being the prospective rider, providing, by the vehicle, a ride to the person, and prompting, in response to the determining, another vehicle to pick up the prospective rider. The prompting can be while the rider is located inside the vehicle. Even though the prospective rider might not receive a ride from the intended vehicle, at least the person will receive a ride and the prospective rider will eventually receive a ride (e.g., from a different vehicle or from the original vehicle once the vehicle has finished providing the ride to the person).

In some embodiments, a method of using a self-driving vehicle comprises receiving, by a vehicle management system, a first identity indicator of a first remote computing device of a prospective rider, wherein the first identity indicator is associated with a user account; detecting wirelessly, by the vehicle at least partially in response to the prospective rider requesting a ride, a second identity indicator of a second remote computing device of a person; sending, by the vehicle, the second identity indicator to the vehicle management system; and/or determining, by the vehicle management system, that the second identity indicator is indicative of being associated with the user account.

Several embodiments comprise providing, by the vehicle, the ride to the person (e.g., before, while, after) determining that the second identity indicator is indicative of being associated with the user account. Some methods comprise billing the user account of the prospective rider for the ride in response to determining that the second identity indicator is indicative of being associated with the user account. The first remote computing device and the second remote computing device can be a single smartphone or can be different smartphones.

In some embodiments, the first identity indicator is a first identification code configured to be transmitted wirelessly. The second identity indicator can be a second identification code configured to be transmitted wirelessly. Detecting the second identity indicator can comprise receiving, by the vehicle, the second identification code via a direct wireless communication from the second remote computing device.

In several embodiments, detecting the second identity indicator occurs while the second remote computing device is located within a direct detection range of the vehicle. Receiving the first identity indicator can occur in response to detecting the second identity indicator and/or in response to detecting the person waiting for a ride. Receiving the first identity indicator can occur while the person is located outside of the direct detection range.

Some embodiments include a system comprising a vehicle management system configured to receive a first identity indicator of a prospective rider, and a self-driving vehicle configured to detect a second identity indicator of a person and send the second identity indicator to the vehicle management system. The vehicle management system can be configured to determine that the first and second identity indicators are indicative of the person being the prospective rider.

In several embodiments, the vehicle is configured to provide a ride to the person, and the system is configured to bill a user account of the prospective rider for the ride. The vehicle can be configured to detect the person while the person is located within a direct detection range of the vehicle. In some embodiments, the vehicle management system is configured to receive the first identity indicator at least one of in response to the vehicle detecting the second identity indicator and while the person is located outside of the direct detection range.

The second identity indicator can be identification data, and the vehicle can be configured to detect the identification data from a remote computing device of the person via a direct wireless communication from the remote computing device to the vehicle.

In some embodiments, the vehicle management system is configured to receive the first identity indicator via an indirect wireless communication. In embodiments, the second identity indicator comprises a passcode entered by the person while the person is located within a direct detection range of the vehicle.

The second identity indicator can comprise a picture of the person. In such embodiments, the system can further comprise a camera coupled to the vehicle, wherein the camera is configured to take the picture. The second identity indicator can comprise a fingerprint of the person. Accordingly, the system can further comprise a fingerprint sensor coupled to the vehicle, wherein the fingerprint sensor is configured to detect the fingerprint. Even still, the second identity indicator can comprise a sound emitted by the person. The system can thereby further comprise a speaker coupled to the vehicle, wherein the speaker is configured to detect the sound. The second identity indicator may comprise a physical trait of the person. In such embodiments, the system may further comprise a biometric device coupled to the vehicle, wherein the biometric device is configured to detect the physical trait.

In several embodiments, the vehicle management system is configured to authorize the vehicle to provide a ride to the person in response to the vehicle management system determining that the first and second identity indicators are indicative of the person being the prospective rider. The vehicle management system may be configured determine that the first and second identity indicators are indicative of the person being the prospective rider while the person is at least one of waiting for the ride and located in the vehicle. In some embodiments, the vehicle management system is configured to receive the first identity indicator prior to the vehicle detecting the second identity indicator. Even still, embodiments of the vehicle management system may be configured to receive the first identity indicator prior to the person waiting for the ride.

In some embodiments, the vehicle management system is located remotely relative to the vehicle. The vehicle may be configured to send a wireless communication having the second identity indicator to the vehicle management system. The vehicle may also be configured to receive authorization for the vehicle to provide a ride to the person in response to the vehicle sending the wireless communication and the vehicle management system determining that the first and second identity indicators are indicative of the person being the prospective rider.

In several embodiments, the vehicle management system is physically coupled to the vehicle such that the vehicle is configured to transport the vehicle management system. In some embodiments, the vehicle management system is integrated into the vehicle as original equipment, such as an on-board system. In some embodiments, the vehicle management system is configured to be added onto an existing vehicle, as an after-market add-on system. In such embodiments, the vehicle management system may be configured to be physically coupled to a specific model of vehicle or a wide range of vehicles.

In embodiments, the system may further comprise a speaker and a microphone system coupled to the vehicle. The speaker and the microphone system may be configured to enable two-way audio communication and initiate the two-way communication between the person and a human representative of the vehicle who is located remotely relative to the vehicle in response to the person entering the vehicle.

The system may be configured to initiate a two-way audio communication between the person and a human representative of the vehicle while the human representative is located remotely relative to the person and the vehicle. The vehicle may be configured to detect at least one of the vehicle moving within a proximity range of the person, the person approaching the vehicle, the person entering the vehicle, and the person being located in the vehicle.

In some embodiments, the vehicle management system is configured to determine that the first and second identity indicators are not indicative of the person being the prospective rider. The system may be configured to initiate a two-way audio communication between the person and a human representative of the vehicle while the human representative is located remotely relative to the person and the vehicle.

The vehicle management system may be configured to determine that the first and second identity indicators are not indicative of the person being the prospective rider. The system may be configured to instruct the person to exit the vehicle.

Even still, the vehicle management system may be configured to determine that the first and second identity indicators are not indicative of the person being the prospective rider. Accordingly, the vehicle management system may be configured to prompt another vehicle to pick up the prospective rider.

Some embodiments include a system comprising a vehicle management system configured to receive a first identity indicator of a first remote computing device of a prospective rider. The first identity indicator can be associated with a user account. The system can also include a self-driving vehicle configured to detect wirelessly a second identity indicator of a second remote computing device of a person at least partially in response to the prospective rider requesting a ride. The vehicle can be configured to send the second identity indicator to the vehicle management system. The vehicle management system can thereby be configured to determine that the second identity indicator is indicative of being associated with the user account.

In several embodiments, the vehicle is configured to provide the ride to the person in response to the system billing the user account of the prospective rider for the ride. In embodiments, the first remote computing device and the second remote computing device are a single smartphone. Stated differently, in some embodiments, the first remote computing device and the second remote computing device are the same.

In some embodiments, the first identity indicator is a first identification code configured to be transmitted wirelessly and the second identity indicator is a second identification code configured to be transmitted wirelessly by the system. The vehicle may be configured to receive the second identification code via a direct wireless communication from the second remote computing device.

In some embodiments, the vehicle is configured to detect the second identity indicator while the second remote computing device is located within a direct detection range of the vehicle. In some embodiments, the vehicle management system may be configured to receive the first identity indicator in response to the vehicle detecting wirelessly the second identity indicator. The vehicle management system may be configured to receive the first identity indicator while the person is located outside of the direct detection range.

Any of the features of each embodiment can be applicable to all aspects and embodiments identified herein. Moreover, any of the features of an embodiment is independently combinable, partly or wholly with other embodiments described herein in any way (e.g., one, two, three, or more embodiments may be combinable in whole or in part). Further, any of the features of an embodiment may be made optional to other aspects or embodiments. Any aspect or embodiment of a method can be performed by a system or apparatus of another aspect or embodiment, and any aspect or embodiment of a system can be configured to perform a method of another aspect or embodiment.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates a perspective view of a self-driving vehicle, according to some embodiments.

FIG. 2 illustrates a diagrammatic view of the self-driving vehicle shown in FIG. 1, according to some embodiments.

FIGS. 3-6 illustrate diagrammatic views of methods of using the self-driving vehicle shown in FIG. 1, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Self-driving vehicles will save tens of thousands of lives per year. The majority of vehicle-related deaths are caused by driver errors. Tests have shown that self-driving vehicles nearly eliminate self-inflicted accidents (although they are not immune to accidents caused by human drivers of other vehicles).

Self-driving vehicles typically have unlimited attention spans and can process complex sensor data nearly instantaneously. (Alphabet Inc. and Tesla Motors Inc. have built self-driving vehicles.) The ability of self-driving vehicles to save lives is so impressive that society has a moral imperative to develop self-driving technology such that it can be widely adopted.

Self-driving vehicles, however, have shortcomings. Although self-driving vehicles excel under “normal” driving conditions, they sometimes struggle with new situations that often would not be overly difficult for a human. Many of the embodiments described herein enable a hybrid approach that leverages the exceptional abilities of self-driving vehicles while soliciting human interaction in select situations. The resulting combination of machine intelligence and human intelligence significantly enlarges the potential of self-driving vehicles in a manner that will enable self-driving vehicles to become widespread much faster than would otherwise be the case.

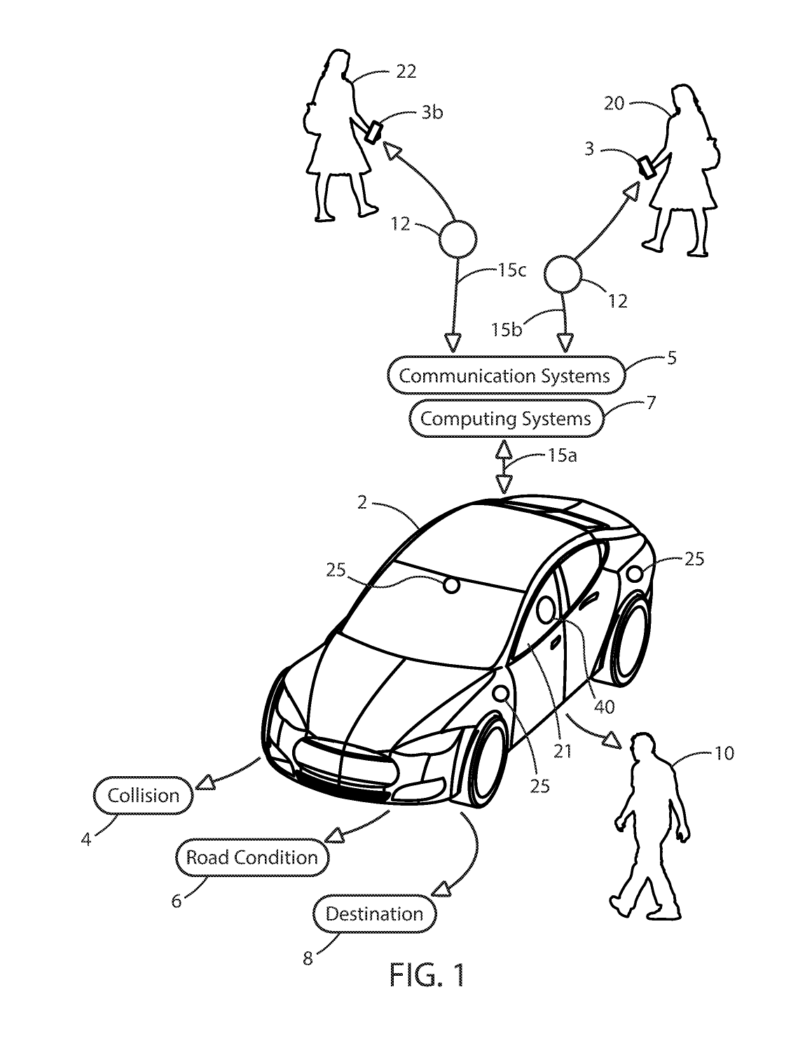

FIG. 1 illustrates a perspective view of a self-driving vehicle 2, which can detect collisions 4, road conditions 6, destinations 8, people 10, and other items. The vehicle 2 can communicate with remote computing devices 3 (e.g., via communication systems 5 and/or via computing systems 7 located remotely relative to the vehicle 2).

In some embodiments, a method of using a self-driving vehicle 2 comprises identifying, by the vehicle 2, a need for a human interaction 12; sending, by the vehicle 2 (e.g., directly or indirectly) in response to identifying the need, a first wireless communication 15a to a remote computing device 3; and/or receiving, by the vehicle 2, the human interaction 12 in response to the first wireless communication 15a. Various embodiments include diverse needs for human interaction 12 and types of human interactions 12.

In many embodiments, the human interaction 12 can be from a remotely located human 20 (e.g., not located inside the vehicle 2) or from a human located inside the vehicle 2 (e.g., from a person who was not actively steering the vehicle 2 at the time the vehicle 2 identified the need for human interaction 12). In some embodiments, a human is located inside the vehicle 2 shown in FIG. 1. In several embodiments, a human is not located inside the vehicle 2 shown in FIG. 1.

In some embodiments, a method of using a self-driving vehicle 2 comprises identifying, by the vehicle 2, a need for a human interaction 12; notifying, by the vehicle 2 in response to identifying the need, a human 20 regarding the need; and/or receiving, by the vehicle 2, the human interaction 12 in response to the notifying.

In embodiments that include elements such as sending, by the vehicle 2, a first wireless communication 15a to a remote computing device 3, the vehicle 2 can perform these elements of claimed methods by using the vehicle 2 plus by using intermediary communication systems 5, 7 such as wireless networks, cellular networks, telephone networks, Internet systems, servers, cloud computing, remotely located computers, satellite systems, communication systems, and any other suitable means of enabling the vehicle 2 to send communications to a remote computing device 3. Thus, while the vehicle 2 is used to send wireless communications 15a to the remote computing device 3, as used herein, the vehicle 2 can use intermediary communication systems 5, 7 to accomplish claimed method elements. For example, the vehicle 2 may send wireless communications 15a to the remote computing device 3 and/or receive wireless communications 15a from the remote computing device 3 via intermediary communication systems 5, 7, which can serve as a communication bridge between the vehicle 2 and the remote computing device 3.

The vehicle can send a wireless communication 15a to the intermediary communication systems 5, 7. Then, the intermediary communication systems 5, 7 can send wireless communications 15b, 15c to remote computing devices 3, 3b (in response to receiving the wireless communication 15a). The intermediary communication systems 5, 7 can also enable the remote computing devices 3, 3b to wirelessly communicate with each other.

The people 20, 22 can see information regarding the vehicle 2 on their computing devices 3, 3b, and then can respond to the information via their computing devices 3, 3b. Their responses can be sent to the vehicle (e.g., wirelessly) via the intermediary communication systems 5, 7.

In many embodiments, the vehicle 2 can perform any of the elements autonomously (e.g., without a person located in the car performing the elements even if the car is transporting a passenger).

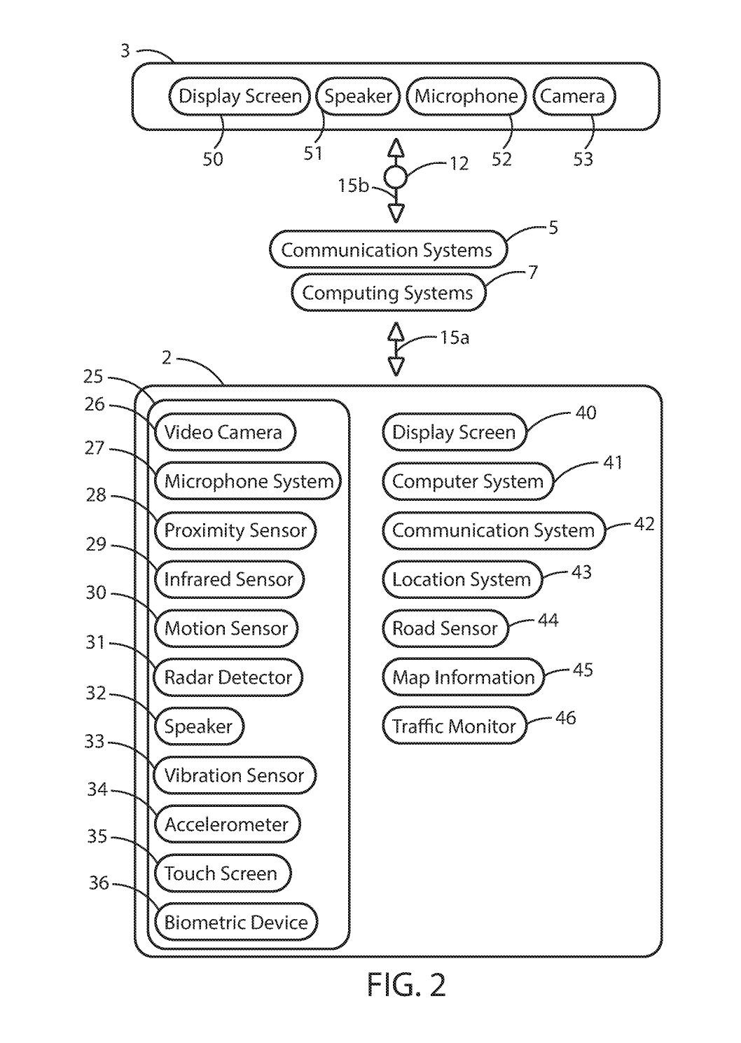

FIG. 2 illustrates a diagrammatic view of a vehicle 2 communicatively coupled to a remote computing device 3. The vehicle 2 can be communicatively coupled to the remote computing device 3 via wireless communication 15a, 15b enabled by communication systems 5 and/or computing systems 7 that are located remotely relative to the vehicle 2.

The remote computing device 3 can be a smartphone, a tablet computer, a laptop computer, a desktop computer, a server, and/or any type of computer that is located remotely relative to the vehicle 2. In some embodiments, the remote computing device is an iPhone made by Apple Inc. or an Android phone based on software made by Alphabet Inc. The remote computing device 3 can comprise a speaker 51 configured to emit sounds, a microphone 52 configured to record sounds, and a display screen 50 configured to display images.

The display screen 50 of the remote computing device 3 can display pictures and videos recorded by a video camera 26 of the vehicle 2. The display screen 40 of the vehicle 2 can display pictures and videos recorded by a video camera 53 of the remote computing device 3.

The vehicle 2 can comprise a sensor and communication module 25. The sensor and communication module 25 can comprise a video camera 26, a microphone system 27, a proximity sensor 28, an infrared sensor 29, a motion sensor 30, a radar detector 31, a speaker 32, a vibration sensor 33, an accelerometer 34, a touch screen 35, and/or a biometric device 36. The touch screen 35 can be configured to enable a person to enter a code (e.g., a rider identification verification code, a billing code) and sign (e.g., to accept payment liability for a ride). The biometric device 36 can be configured to scan, sense, and/or analyze a physical trait of a person. The sensor and communication model 25 can be located outside and/or inside of the vehicle 2.

The video camera 26, the microphone system 27, the proximity sensor 28, the infrared sensor 29, the motion sensor 30, and/or the radar detector 31 can be arranged and configured to detect a person 10 located outside the vehicle 2 and/or located inside the vehicle 2. The computer system 41 can analyze videos (taken by the video camera 26) using machine vision software and techniques to identify a person 10 (shown in FIG. 1) located outside the vehicle 2.

The vibration sensor 33 and/or the accelerometer 34 can be arranged and configured to detect knocks on glass, sheet metal, and/or on any portion of the vehicle 2. For example, a person 10 (shown in FIG. 1) can touch the vehicle 2, which can cause the vehicle 2 to send a notification to the remote computing device 3. The vibration sensor 33 and/or the accelerometer 34 can also be arranged and configured to detect a collision 4 (shown in FIG. 1) of the vehicle 2 hitting an external object, such as another car, a rail, or a tree.

The video camera 26 can be arranged and configured to detect traffic and/or road conditions (e.g., via machine vision). The module 25 and/or the road sensor 44 can comprise a light configured to reflect off a road surface and a light detector that senses the reflected light to analyze road conditions (e.g., ice or water on the road beneath the vehicle 2). In some embodiments, the road sensor 44 comprises a camera 26 facing towards a road to analyze road conditions.

The module 25 can be located inside the vehicle 2 such that the module 25 is arranged and configured to sense and video record people located inside the vehicle 2.

Referring now to FIG. 1, the module 25 can be face outward from the vehicle 2 such that the module 25 is arranged and configured to sense and video record people 10 located outside the vehicle 2. FIG. 1 illustrates several modules 25. The module 25 can face outward through a windshield or another window of the vehicle 2. The module 25 can be located outside the windshield or outside another window of the vehicle 2. The module 25 can be attached to and/or face outward from a sheet metal portion of the vehicle 2. The module 25 can be attached to and/or face outward from a headlight portion, taillight portion, fog light portion, and/or any other translucent or transparent portion of the vehicle 2.

Referring now to FIG. 2, the vehicle 2 can also comprise a display screen 40, a computer system 41, a communication system 42, a location system 43, a road sensor 44, map and traffic information 45, and a traffic monitoring system 46.

Referring now to FIGS. 1 and 2, the display screen 40 can face outward from the vehicle 2 (as shown in FIG. 1). The display screen 40 can be coupled to any exterior surface of the vehicle 2. In some embodiments, the display screen 40 is integrated into a window (e.g., the driver's side window 21) of the vehicle 2. Thus, a person 10 located outside the window 21 can see information and videos on the display screen 40 in an orientation that is not inverted (e.g., as would be the case if the display screen was oriented for viewing by people located inside the vehicle.

The display screen 40 can be opaque or at least partially transparent or translucent. For example, the display screen 40 can be a BMW Head-Up Display made by Bayerische Motoren Werke AG (“BMW”) with the following changes: The display screen 40 can face outwards (rather than inwards towards the driver) such that the display screen 40 is arranged and configured for viewing by a person 10 located outside the vehicle 2 (rather than by the driver of the vehicle 2). The display screen 40 can be coupled to and/or located in a side window (e.g., the driver's side window 21) rather than in the windshield. The display screen 40 can display a streaming video recorded by a remote computing device 3 (rather than display data such as navigation arrows and speed information). The streaming video can show a remotely located representative 20 of the vehicle 2 to a person 10 located outside of the vehicle (e.g., while no person and/or no driver is located in the vehicle 2).

The communication system 42 can be arranged and configured to enable the vehicle 2 to communicate with a remote computing device 3 (e.g., via communication systems 5 and computing systems 7 located remotely relative to the vehicle 2). The communication system 42 can use cellular communication systems and/or Bluetooth communication systems.

The location system 43 can receive location information from Global Positioning Systems (GPS) and/or from location beacons (e.g., iBeacon from Apple Inc.). The location system 43 can also use accelerometers 34 and/or compasses to track distance traveled and/or direction traveled.

The vehicle 2 (e.g., a memory of the vehicle 2) can include map and traffic information 45. The map information can include a layout of roads around the world. The traffic information can be based on historic or approximately real-time traffic data. The traffic data can be sent to the vehicle 2 by communication systems 5 and/or by computing systems 7.

The traffic monitoring system 46 can monitor traffic by the vehicle 2 (e.g., via vehicle sensors and cameras) and can receive traffic information from communication systems 5 and/or by computing systems 7.

The road sensor 44 can monitor the road for ice, snow, water, gravel, potholes, and many other road surface traits. The road sensor 44 can use the camera 26 (for vision recognition of road surface traits). The vehicle 2 can also receive road surface information from communication systems 5 and/or computing systems 7.

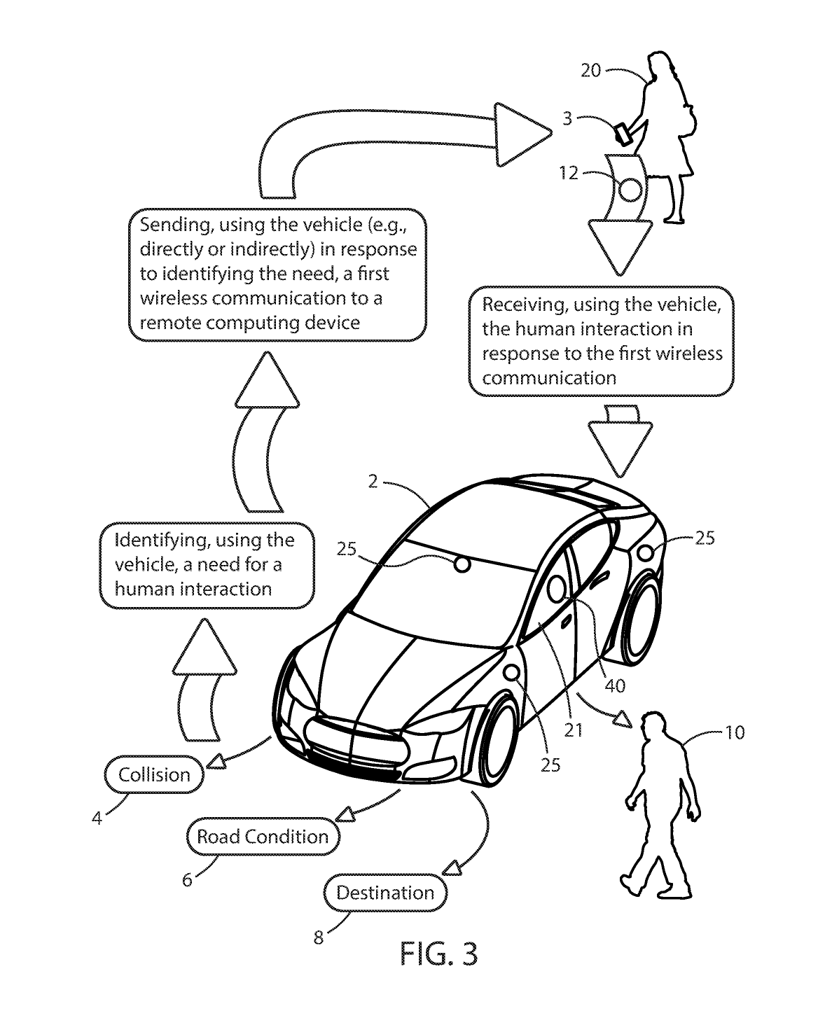

FIG. 3 illustrates a diagrammatic view of methods of using a self-driving vehicle 2, according to some embodiments. Methods can comprise identifying, by the vehicle 2, a need for a human interaction 12. Various needs for human interaction 12 are illustrated in FIG. 13. Additional needs for human interaction 12 are described herein. Needs for human interaction 12 include, but are not limited to collisions 4, hazardous road conditions 6, destination-related situations 8, and people 10 with whom the representative 20 might want to speak.

The vehicle 2 can detect collisions 4 (e.g., using an accelerometer 34 shown in FIG. 2), road conditions 6, and relationships to destinations. For example, the vehicle's location system 43 shown in FIG. 2 can determine the vehicle's current location and the location of the destination via GPS.

The module 25 shown in FIG. 2 can detect people 10 located outside the vehicle 2. The person shown in FIG. 3 can be a person representing a destination, a potential passenger, a gas station attendant, a person seeking to speak with a representative of the vehicle 2 (e.g., because the person's car was in a collision with the vehicle 2), or any other type of person described herein.

Methods of using a self-driving vehicle 2 can comprise sending, by the vehicle 2 (e.g., directly or indirectly) in response to identifying the need, a first wireless communication 15a to a remote computing device 3; and/or receiving, by the vehicle 2, the human interaction 12 in response to the first wireless communication 15a.

People 10 typically expect to find a representative 20 located inside the vehicle 2. This expectation can make life problematic for self-driving vehicles 2. For example, when a police officer pulls a vehicle 2 over, she expects to find a person inside the vehicle 2. Imagine the police officer's surprise when she discovers the vehicle 2 she just pulled over is empty. The police officer might reasonably assume that the representative 20 has fled on foot, which is a very serious crime that in some cases can be punishable by over one year in prison. Enabling the representative 20 of the vehicle 2 to talk with the police officer in response to the police officer pulling the vehicle 2 over can quickly de-escalate an otherwise treacherous situation.

There are many situations in which an ability for a remotely located representative 20 of the self-driving vehicle 2 to interact with people 10 located outside the vehicle 2 is extremely advantageous. Thus, there is a need for systems and methods that enable a remotely located representative 20 of the vehicle 2 to interact with people 10 located near the vehicle 2 (e.g., within 30 feet of the vehicle).

Referring now to FIGS. 2 and 3, in some embodiments, identifying the need (for human interaction 12) comprises detecting, by the vehicle 2, a person 10 located outside of the vehicle 2 and located within 6 feet of a driver's side window 21 of the vehicle 2. Detecting by the vehicle 2 can comprise detecting by at least one of a video camera 26, a microphone system 27, a proximity sensor 28, an infrared sensor 29, a radar detector 31, and a motion sensor 30 of the vehicle 2.

In some cases (such as when a police officer pulls the vehicle 2 over), the person 10 might knock on the vehicle 2 in an effort to get the attention of a representative 20 of the vehicle 2. (This is especially true if the person 10 does not realize that there is not a person inside the vehicle 2.)

In several embodiments, identifying the need (for human interaction 12) comprises detecting, by the vehicle 2, a knock on a portion of the vehicle 2. Detecting by the vehicle 2 can comprise detecting at least one of a sound by a microphone system 27 (of the vehicle 2) and a vibration by a vibration sensor 33 (of the vehicle 2). The sound and the vibration can be indicative of a person knocking on the vehicle 2 (e.g., knocking on an exterior of the vehicle 2, knocking on a glass window 21 of the vehicle 2, knocking on sheet metal of the vehicle 2).

In some cases, a person 10 seeking to speak with someone inside the vehicle 2 will speak in the direction of the vehicle 2. Even though a representative 20 might not be in the vehicle 2, the vehicle 2 can look for indicators that the person 10 is seeking to talk with a representative 20 of the vehicle. If the vehicle 2 determines that the odds are above a predetermined threshold that the person 10 is seeking to speak with a representative 20 of the vehicle 2, then the vehicle 2 can send a notification to the remote computing device 3 associated with the representative 20.

In some embodiments, identifying the need (for human interaction 12) comprises detecting, by a microphone system of the vehicle 2, an audible voice (e.g., from the person 10) and determining, by the vehicle 2, that the audible voice originated from outside the vehicle 2. Receiving remote human interaction 12 can comprise receiving audio data recorded by a microphone 52 of the remote computing device 3. The vehicle 2 can comprise a speaker 32 arranged and configured to emit sound outside the vehicle 2 to enable a person 10 located outside the vehicle 2 to hear the sound. Embodiments can also comprise emitting outside the vehicle 2, by the speaker of the vehicle 2, the sound based on the audio data; recording, by the microphone system 27 of the vehicle 2, a verbal response to the sound from the person 10 located outside the vehicle 2; and/or sending automatically, by the vehicle 2, a recording of the verbal response to the remote computing device 3.

In several embodiments, the vehicle 2 further comprises a display screen 40 facing outward such that the person 10 located outside the vehicle 2 can see information on the display screen 40. Receiving the remote human interaction 12 can comprise receiving a video recorded by a video camera 53 of the remote computing device 3. Embodiments can comprise showing the video on the display screen 40 facing outward such that the vehicle 2 is configured to enable the person 10 located outside the vehicle 2 to see the video.

In several embodiments, identifying the need (for human interaction 12) comprises detecting, by a microphone system 27 of the vehicle 2, an audible voice, and determining, by the vehicle 2, that the audible voice is greater than a threshold configured to help the vehicle 2 differentiate between background voices and voices directed to the vehicle 2 from a location outside of the vehicle 2.

In some embodiments, identifying the need (for human interaction 12) comprises detecting, by a microphone system 27 of the vehicle 2, an audible voice of a person; determining, by the vehicle 2, at least one of the audible voice originated outside the vehicle 2 and the person is located outside the vehicle 2; and/or determining, by the vehicle 2, that the voice has asked a question. In several embodiments, the vehicle 2 determines that the voice has asked a question by analyzing the words spoken by the voice to identify a question and/or by determining that an intonation of the voice is indicative of a question.

In some embodiments, a microphone system of the vehicle 2 comprises a first microphone (e.g., of a first module 25) and a second microphone (e.g., of a second module 25). The first module 25 is spaced apart from the second module 25 such that the first and second microphones are spaced apart from each other. As shown in FIG. 3, the vehicle 2 includes multiple modules 25, which each have at least one microphone.

Identifying the need (for human interaction 12) can comprise detecting, by the first and second microphones of the vehicle 2, an audible voice; comparing, by the vehicle 2, a first voice signal detected by the first microphone and a second voice signal detected by the second microphone to evaluate a directionality of the voice; and/or determining, by the vehicle 2, that the directionality is indicative of the voice being directed towards the vehicle 2.

The vehicle 2 can use several factors to determine the directionality of the voice. For example, the vehicle can analyze wave lengths, tones, and time lags of voices. The relationships of these factors can provide indications of the directionality of the voice.

In some embodiments, the vehicle 2 has a first microphone 27 on the front of the vehicle 2, a second microphone 27 on the driver's side of the vehicle 2, a third microphone 27 on the back of the vehicle 2, and a fourth microphone 27 on the passenger's side of the vehicle 2. (As used herein, the passenger's side is opposite the driver's side even though passengers can actually be located in seats in any portion of the vehicle.)

The vehicle 2 acts as an obstruction to sound. Although some sounds pass through the vehicle 2 in an attenuated manner, a voice directed towards the driver's side of the vehicle 2 will be sensed as having a greater magnitude by the second microphone 27 (located on the driver's side) than by the fourth microphone 27 (located on the passenger's side). In many cases, this same voice will also be sensed as having a greater magnitude by the second microphone 27 (located on the driver's side) than by the first microphone 27 (on the front of the vehicle 2) and the third microphone 27 (on the back of the vehicle 2). The greater magnitude sensed by the second microphone 27 (located on the driver's side) can be indicative of the voice being directed towards the vehicle 2.

Time lag can also help the vehicle 2 determine the directionality of the voice. For example, when a person emitting a voice is located near the driver's side of the vehicle 2, the voice directed towards the driver's side of the vehicle 2 will be sensed by the second microphone 27 (located on the driver's side) before being sensed by the fourth microphone 27 (located on the passenger's side).

In some cases, two-way audio communication between the representative 20 and the person 10 (via the vehicle 2) is not as helpful as also including video communication between the representative 20 and the person 10. The video communication can be one-way (e.g., a video recorded by the vehicle 2 is sent to the remote computing device 3) or can be two-way (e.g., a video recorded by the vehicle 2 is sent to the remote computing device 3 and a video recorded by the remote computing device 3 is sent to the vehicle 2 for display on the display screen 40).

In several embodiments, the vehicle 2 comprises a speaker 32 arranged and configured to emit a first sound outside the vehicle 2 to enable a person 10 located outside the vehicle 2 to hear the first sound. The vehicle 2 can comprise a first microphone 27 arranged and configured to record a second sound emitted by the person 10 located outside the vehicle 2. The vehicle 2 can comprise a first video camera 26 arranged and configured to record a first video of an area outside the vehicle 2.

Receiving remote human interaction 12 (by the vehicle 2) can comprise receiving audio data recorded by a second microphone 52 of the remote computing device 3. Embodiments can comprise emitting outside the vehicle 2, by the speaker 32 of the vehicle 2, the first sound based on the audio data; recording, by the first microphone 27 of the vehicle 2, a verbal response from the person 10 located outside the vehicle 2 to the first sound; recording, by the first video camera 26, the first video of the area outside the vehicle 2 during the verbal response; and/or sending, by the vehicle 2, the first video and a recording of the verbal response to the remote computing device 3.

In some embodiments, the vehicle 2 further comprises a display screen 40 facing outward such that the person 10 located outside the vehicle 2 can see information on the display screen 40. Receiving the remote human interaction 12 can comprise receiving a second video recorded by a second video camera 53 of the remote computing device 3. Embodiments can comprise showing the second video on the display screen 40 facing outward such that the vehicle 2 is configured to enable the person 10 located outside the vehicle 2 to see the second video.

Referring now to FIGS. 1 and 2, some vehicles have one, two, three, four, or more representatives 20, 22. In some cases, facilitating communication that comprises multiple representatives 20, 22 is highly beneficial.

For example, if the vehicle 2 is in a collision, one representative 20 might be the owner of the vehicle 2 while the other representative 22 works for an insurance company that provides insurance for the vehicle 2. If the vehicle 2 gets into trouble, one representative 20 might be a minor (e.g., with or without a driver's license) who was controlling the vehicle 2 while the other representative 22 might be an adult guardian of the minor. If the vehicle 2 is a rental vehicle, one representative 20 might be the person who rented the vehicle while the other representative 22 works for the car rental company.

In several embodiments, the vehicle 2 comprises a video camera 26 and a speaker 32 arranged and configured to emit a first sound and a second sound outside the vehicle 2 to enable a person 10 located outside the vehicle 2 to hear the first and second sounds. Embodiments can comprise initiating, by the vehicle 2, a three-way audio communication between the person 10 located outside the vehicle 2, a first human representative 20 of the vehicle 2, and a second human representative 22 of the vehicle 2. The first human representative 20 and the second human representative 22 can be located remotely relative to the vehicle 2. The remote computing device 3 can be a first remote computing device 3 associated with the first human representative 20. A second remote computing device 3b can be associated with the second human representative 22.

In some embodiments, three-way audio communication can comprise receiving, by the vehicle 2, a first audio data recorded by a microphone 52 of the first remote computing device 3, and a second audio data recorded by a microphone of the second remote computing device 3b; emitting outside the vehicle 2, by the speaker 32 of the vehicle 2, the first sound based on the first audio data; emitting outside the vehicle 2, by the speaker 32 of the vehicle 2, the second sound based on the second audio data; and/or recording, by a microphone system 27 of the vehicle 2, a verbal response from the person 10 located outside the vehicle 2, and sending a first recording of the verbal response to the first remote computing device 3 and the second remote computing device 3b.

Several embodiments comprise recording, by the microphone system 27 of the vehicle 2, a verbal request from the person 10 located outside the vehicle 2, and sending a second recording of the verbal request to the first remote computing device 3 and the second remote computing device 3b. Emitting outside the vehicle 2, by the speaker 32 of the vehicle 2, the first sound based on the first audio data can occur in response to the verbal request comprising a first request. Emitting outside the vehicle 2, by the speaker of the vehicle 2, the second sound based on the second audio data can occur in response to the verbal request comprising a second request.

Although self-driving vehicles 2 have dramatically lower collision rates than human-driven vehicles, self-driving vehicles 2 are not immune to collisions (especially due to mistakes by human-driven vehicles). In the event of a collision, human interaction is very beneficial. A representative 20 of the vehicle 2 can talk to the person 10 who was driving the other car in the collision (e.g., to exchange insurance information). The representative 20 of the vehicle 2 can be an owner of the vehicle 2, an insurance agent who manages insurance for the vehicle 2, a lawyer, or any other person suitable to help take steps to resolve the challenges associated with the collision.

In several embodiments, the vehicle 2 comprises a video camera 26 and a speaker 32 arranged and configured to emit sound outside the vehicle 2 to enable a person 10 located outside the vehicle 2 to hear the sound. Identifying the need (for human interaction 12) can comprise detecting, by the vehicle 2, a collision 4 of the vehicle 2. The first wireless communication 15a (sent to the remote computing device 3) can comprise a notification regarding the collision 4 and a video of the collision 4 taken by the video camera 26 of the vehicle 2.

Some embodiments comprise initiating, in response to the detecting the collision 4, a two-way audio communication between the person 10 located outside the vehicle 2 and a human representative 20 of the vehicle 2 while the human representative 20 is located remotely relative to the vehicle 2. The two-way audio communication can comprise receiving, by the vehicle 2, audio data recorded by a microphone 52 of the remote computing device 3; emitting outside the vehicle 2, by the speaker 32 of the vehicle 2, the sound based on the audio data; recording, by a microphone system 27 of the vehicle 2, a verbal response to the sound from the person 10 located outside the vehicle 2; and/or sending a recording of the verbal response to the remote computing device 3.

The vehicle 2 can be traveling towards a destination 8. For example, the destination 8 may be a flower shop or a dry cleaning business. When the vehicle 2 arrives at the business, the representative 20 may want to call someone associated with the business to let her know the vehicle 2 has arrived and/or to ask her to load flowers, clean clothes, or any other item into the vehicle 2. Once the vehicle 2 is loaded, the vehicle 2 can continue to its next destination (which may be its home where the representative 20 is waiting to unload the items from the vehicle 2).

In several embodiments, identifying the need (for human interaction 12) comprises at least one of approaching a destination 8, being within two minutes of arriving at the destination 8, and arriving at the destination 8. In response to the identifying the need, some embodiments comprise contacting a representative 20 of the vehicle 2 via the remote computing device 3 and/or prompting the representative 20 to communicate with a person who is at least one of at the destination 8 and representing the destination 8 (e.g., while the representative 20 of the vehicle 2 is located remotely relative to the destination 8). The person representing the destination 8 can be located at the destination 8 or located remotely relative to the destination 8. For example, the person representing the destination 8 can be located at a call center that is in a different location than the destination 8.

In some embodiments, identifying the need (for human interaction 12) comprises at least one of being within two minutes of arriving at a destination 8 and arriving at the destination 8. Embodiments can comprise prompting a person at the destination 8 to at least one of load an inanimate object into the vehicle 2 and unload the inanimate object from the vehicle 2.

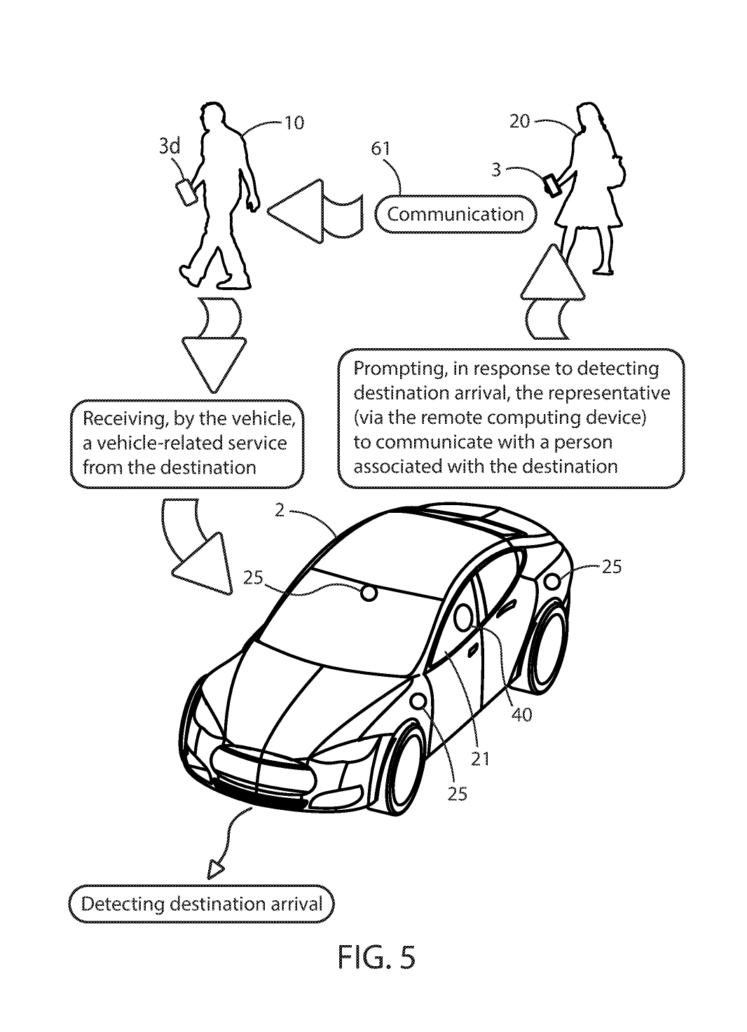

Referring now to FIG. 5, the vehicle 2 can detect that the vehicle is close to the destination, within 10 minutes of arriving at the destination, within 5 minutes of arriving at the destination, within 2 minutes of arriving at the destination, within three miles of the destination, within one mile of the destination, and/or has arrived at the destination. In response to any of these destination-related states, the vehicle 2 can prompt the representative 20 (e.g., via the remote computing device 3) to send a communication 61 (e.g., directly or indirectly) to a computing device 3d (e.g., a telephone, a computer) of a person 10 who is at least one of at the destination 8 and representing the destination 8. The prompt can include information regarding a vehicle-related service (e.g., load the vehicle 2, unload the vehicle 2, service the vehicle 2, add fuel to the vehicle 2, wash the vehicle 2, park the vehicle 2, store the vehicle 2, end a vehicle rental period, return the vehicle 2 to a rental company). Then, the vehicle 2 can receive a vehicle-related service (e.g., from the destination) and/or in response to the prompt and/or in response to the communication 61.

Referring now to FIGS. 1-3 and 5, the vehicle 2 may travel to many different types of destinations 8. In some embodiments, the destination 8 is a fuel station or a parking garage, which often are not setup to handle driverless vehicles.

In several embodiments, the identifying the need (for human interaction 12) comprises at least one of approaching a fuel station, being within two minutes of arriving at the fuel station, and arriving at the fuel station. As used herein, a “fuel station” is configured to provide at least one of electricity, hydrogen, natural gas, diesel, petroleum-derived liquids, and/or any other substance suitable to provide energy to enable vehicle 2s to move.

In some embodiments, identifying the need (for human interaction 12) comprises at least one of approaching a payment station of a parking garage, being within two minutes of arriving at the payment station, and arriving at the payment station. Embodiments can comprise initiating a two-way audio communication between an attendant 10 of the parking garage and a human representative 20 of the vehicle 2 while the human representative is located remotely relative to the vehicle 2. Embodiments can comprise initiating the two-way audio communication in response to identifying the need for the remote human interaction 12.

In some embodiments, identifying the need for remote human interaction 12 comprises determining, by the vehicle 2, that a person is not located in the vehicle 2. The vehicle 2 can determine that a person is not located in the vehicle 2 using infrared sensors 29, motion sensors 30, and/or video cameras 26.

Referring now to FIGS. 1-3, in several embodiments, identifying the need (for human interaction 12) comprises detecting, by a sensor of the vehicle 2, a condition 6 of a road and/or of a road surface, and determining that the condition 6 is potentially hazardous to the vehicle 2. For example, the road might be blocked, be too narrow, have insufficient overhead clearance, and/or be incomplete. For example, the road surface may be snowy, icy, overly bumpy, have hazardous potholes, and/or have loose gravel. Receiving human interaction 12 can comprise receiving, by the vehicle 2, an instruction based on input from a human 20 (e.g., who can be located remotely relative to the vehicle 2). The input can be in response to the condition 6. The instruction can comprise information regarding how the vehicle 2 should respond to the condition 6 of the road surface.

Instructions can comprise general driving behavior modifications to be applied over an extended period of time (rather than instantaneous modifications such as “turn left 5 degrees right now.”) In several embodiments, the general driving behavior modifications apply to vehicle 2 driving over a period of at least sixty seconds and often for at least five minutes.

For example, the instruction can tell the vehicle 2 to stop driving through a snowy mountain pass or to driver slower than a posted speed limit due to large potholes.

In some embodiments, identifying the need (for human interaction 12) comprises identifying, by the vehicle 2, a discrepancy between an actual road and a road map (e.g., accessible to the vehicle 2 and/or referenced by the vehicle 2). The actual road can be the road on which the vehicle 2 is driving. The road map can be an electronic map.

Receiving the human interaction 12 can comprise receiving, by the vehicle 2 in response to the first wireless communication 15a, an instruction regarding how the vehicle 2 should respond to the discrepancy. The instruction can include the selection of an alternate route.

In several embodiments, identifying the need for the human interaction 12 comprises identifying, by the vehicle 2, an impasse due to at least one of road conditions and traffic conditions. In several embodiments, identifying the need for the human interaction 12 comprises identifying, by the vehicle 2, adverse traffic conditions (e.g., that would cause the vehicle 2 to travel at least 35 percent under the road's speed limit). Receiving the remote human interaction 12 can comprise receiving, by the vehicle 2 in response to the first wireless communication 15a, an instruction regarding how the vehicle 2 should respond to the impasse. The instruction can include the selection of an alternate route.

A self-driving vehicle 2 can be assigned to pick up passengers even when no driver is present in the vehicle 2. A challenge is that the vehicle 2 may inadvertently pick up the wrong passenger. Remote human interaction helps mitigate this challenge.

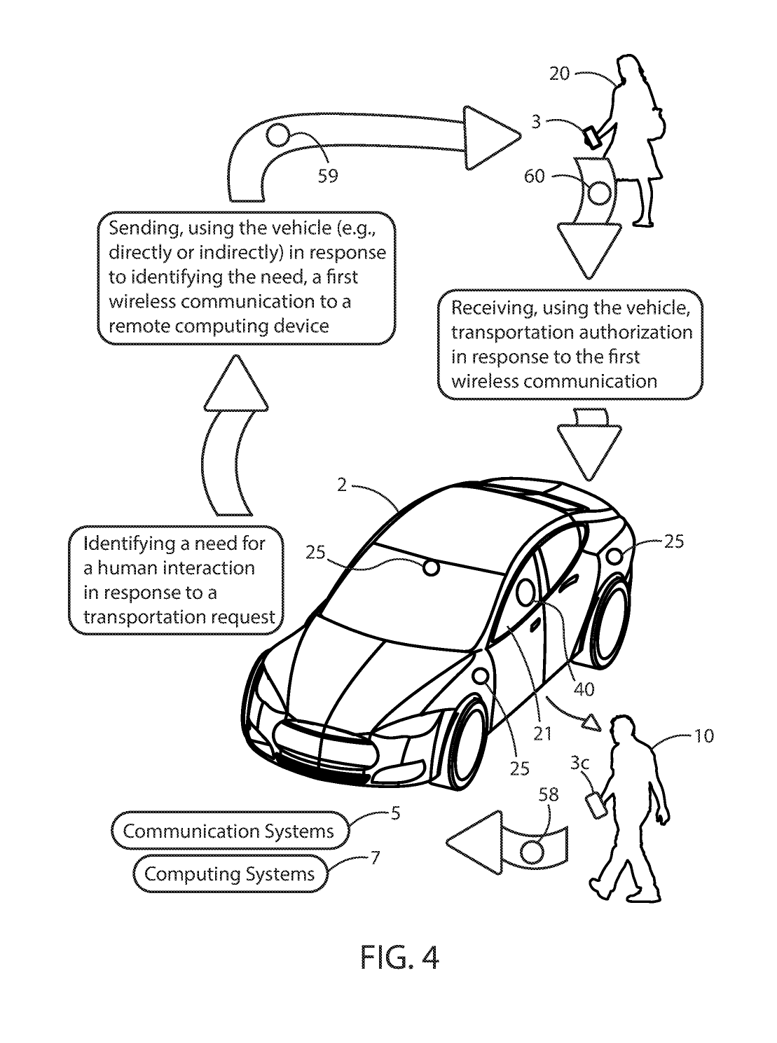

The potential rider 10 can send a transportation request 58 (shown in FIG. 4) to any portion of a vehicle management system, which can comprise communication systems 5, computing systems 7, and/or at least one vehicle 2. Any portion of the vehicle management system (e.g., the vehicle 2, the communication system 5, and/or the computing systems 7) can receive the transportation request 58. The potential rider 10 can use a remote computing device 3c (shown in FIG. 4) to send the transportation request 58.

In some embodiments, identifying the need (for human interaction 12) comprises determining that the vehicle 2 is at least one of within a distance threshold of a potential rider 10 and within a time threshold of arriving at a location of the potential rider 10.

In some embodiments, a first module 25 is located inside a passenger area of the vehicle 2 and additional modules 25 face outward from the vehicle 2 (e.g., to record sounds and images outside the vehicle 2).

Referring now to FIGS. 2-4, several embodiments comprise recording, by a microphone system 27 of the vehicle 2, a sound emitted by the potential rider 10; sending a recording of the sound to the remote computing device 3; and then receiving authorization 60 for the vehicle 2 to transport the potential rider in response to a human 20 hearing the sound via the remote computing device 3 and then authorizing, by the remote computing device 3, the vehicle 2 to transport the potential rider 10.

Some embodiments comprise recording, by a camera 26 of the vehicle 2, a picture showing the potential rider 10; sending the picture to the remote computing device 3; and then receiving authorization 60 for the vehicle 2 to transport the potential rider 10 in response to a human 20 seeing the picture and then authorizing, by the remote computing device 3, the vehicle 2 to transport the potential rider 10.

A vehicle management system can comprise communication systems 5, computing systems 7, and/or at least one vehicle 2. In several embodiments, methods of using a self-driving vehicle 2 comprise identifying, by a vehicle 2 management system, a need for a remote human interaction 12 in response to receiving a transportation request from a potential rider 10; sending, by the vehicle 2 management system in response to identifying the need, a first wireless communication 15b to a remote computing device 3; and/or receiving, by the vehicle 2 management system, the remote human interaction 12 in response to the first wireless communication 15b.

In some embodiments, the first wireless communication 15b comprises at least one identity indicator 59 of the potential rider 10. Receiving the remote human interaction 12 can comprise receiving authorization 60 for the vehicle 2 to transport the potential rider 10 in response to a human representative 20 of the vehicle 2 receiving the identity indicator 59 and then authorizing, by the remote computing device 3, the vehicle 2 to transport the potential rider 10. The human representative 20 can authorize the vehicle 2 to transport the potential rider in response to receiving, analyzing, verifying, and/or seeing the identity indicator 59.

In several embodiments, the vehicle 2 comprises a speaker 32 and a microphone system 27. Embodiments can comprise initiating a two-way audio communication between the potential rider 10 and the human representative 20 in response to at least one of the first wireless communication 15b and the potential rider entering the vehicle 2.

In some embodiments, the vehicle 2 comprises a camera 26. Embodiments can comprise taking a picture, by the camera 26, of the potential rider 10. The identity indicator 59 can comprise the picture. Embodiments can comprise sending the picture to the remote computing device 3.

In several embodiments, the vehicle 2 comprises a microphone system 27. Embodiments can comprise recording, by the microphone system 27, an audible voice of the potential rider 10. The identity indicator 59 can comprise a recording of the audible voice. Embodiments can comprise sending the recording to the remote computing device 3.

When a human driver picks up a passenger, the driver typically looks at the passenger to determine if the passenger is the individual who is supposed to receive a ride. Self-driving vehicles often do not have a human in the vehicle to make this decision. As a result, there is a need for systems and methods that can enable self-driving vehicles to know if they are picking up the correct person.

GPS can help guide the self-driving vehicle to the approximate locate of the person waiting for a ride. The accuracy of GPS, however, is imperfect. In urban areas with tall buildings, the accuracy of GPS can be diminished to the point where there might be many people within the potential pick up area. In addition, at certain events such as concerts, there can be many people waiting for rides from self-driving vehicles. If the incorrect person receives a ride from the self-driving vehicle, the system might bill the wrong prospective rider for the ride.

Sometimes, a criminal will deliberately seek to receive a ride from a self-driving vehicle even though he knows he does not have permission to receive the ride. The criminal might just be seeking a free ride or might be trying to steal the self-driving vehicle (e.g., by instructing the vehicle to drive to an enclosed location such as a salvage yard).

Some embodiments check the identity of a person requesting a ride, and then can check an identity of a person attempting to receive the ride. The system can determine if the person requesting the ride has permission to receive the ride. The system can determine if the person attempting to receive the ride is the correct person.

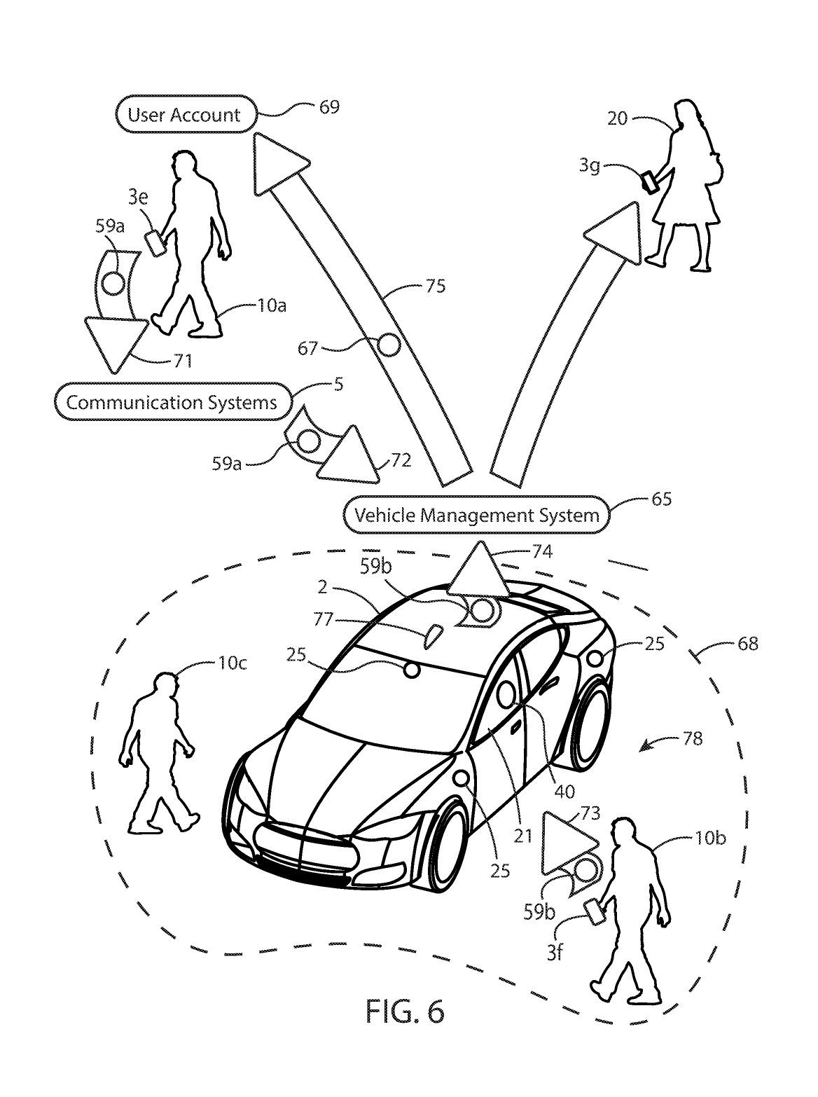

FIG. 6 illustrates a diagrammatic view that represents a prospective rider 10a requesting a ride and a person 10b attempting to receive the ride requested by the prospective rider 10a. The person 10b can be the prospective rider 10a (e.g., at a time after when the prospective rider 10a requests the ride). In alternative cases, the person 10b can be someone other than the prospective rider 10a. For example, the person 10b can be a criminal attempting to “steal” a ride or even steal the vehicle 2.

Referring now to FIG. 6, a prospective rider 10a can be located remotely relative to the vehicle 2 and the vehicle management system 65. The prospective rider 10a can use his remote computing device 3e to request a ride from a vehicle 2. For example, the remote computing device 3e can be configured to run an app that allows the prospective rider 10a to request a ride. In response to the ride request, the vehicle 2 can drive to a pick-up location, which can be the current location of the prospective rider or a different location. The pick-up time can be as soon as possible or a predetermined time (or timeframe) in the future.

The remote computing device 3e can communicate with the vehicle management system 65 directly (e.g., via Bluetooth) or indirectly (e.g., via intermediary communication systems 5).

Once the vehicle 2 arrives at the pick-up location, the vehicle 2 can determine if the person 10b waiting at the pickup location is the prospective rider 10a. The vehicle management system 65 can compare an identity indicator 59a of the prospective rider 10a to an identity indicator 59b of the person 10b waiting at the pick-up location. If the identity indicator 59b of the person 10b waiting for the ride suggests that the person 10b is the prospective rider 10a (and not an incorrect person), then the vehicle 2 can provide a ride to the person 10b. For example, the vehicle 2 can drive the person 10b to a destination received by the remote computing device 3e of the prospective rider 10a, a destination received by the vehicle 2 from a remote computing device 3f of the person 10b, and/or a destination received from the person 10b by a microphone system 27 (shown in FIG. 2) of the vehicle 2.

The person 10b can be located outside the vehicle 2 or can be located inside the vehicle 2. Steps can be performed while the person 10b is located inside or outside of the vehicle 2.

Arrows are shown in FIG. 6; however, communication is not limited to the directions indicated by the arrows. Communications can be directed in directions opposite to the directions indicated by the arrows.

In some embodiments, intermediary communication systems 5 are used to perform each step. Intermediary communication systems 5 can comprise wireless networks, cellular networks, telephone networks, Internet systems, servers, cloud computing, remotely located computers, satellite systems, communication systems, and any other suitable means of enabling communication between the various parts illustrated in FIG. 6.

The vehicle management system 65 can be a portion of the vehicle 2. Communication from the vehicle 2 to the vehicle management system 65 can occur via electrical wires that couple the vehicle management system 65 to other portions of the vehicle 2.

The vehicle management system 65 can be located remotely relative to the vehicle 2. Communication from the vehicle 2 to the vehicle management system 65 can occur via wireless communications (e.g., via communication systems 5).

In some embodiments, methods of using a self-driving vehicle 2 comprise receiving, by a vehicle management system 65, a first identity indicator 59a of a prospective rider 10a. The first identity indicator 59a can be sent from the first remote computing device 3e of the prospective rider 10a via wireless communications to communication systems 5 and then to the vehicle management system 65 (e.g., as indicated by arrows 71, 72).

In several embodiments, a company creates the first identity indicator 59a in response to the potential rider 10a creating a user account 69 or requesting a ride. The company can then send the first identity indicator 59a to the vehicle management system 65 (e.g., via communication systems 5). The vehicle management system 65 can receive the first identity indicator 59a while the prospective rider 10a is located remotely relative to the vehicle 2 and/or prior to the vehicle 2 picking up the person 10b.

The vehicle 2 can be configured to detect (e.g., receive) a second identity indicator 59b of a person 10b (e.g., as indicated by arrow 73). As indicated by arrow 74, the vehicle 2 can also be configured to send the second identity indicator 59b to the vehicle management system 65, which can be located inside the vehicle 2 or can be located remotely relative to the vehicle 2.

In some embodiments, a first portion of the vehicle management system 65 is physically coupled to the vehicle 2 and a second portion of the vehicle management system 65 is located remotely relative to the vehicle 2. The first and second portions of the vehicle management system 65 can be communicatively coupled.

In several embodiments, the vehicle management system 65 can receive the first identity indicator 59a of the prospective rider 10a requesting the ride. The prospective rider 10a can request a ride by using application software (e.g., an “app”) on her smartphone. Then, in response to the ride request, the vehicle management system 65 can receive the first identity indicator 59a of the prospective rider 10a. The first identity indicator 59a can be a name, a username, a code, a picture, a fingerprint, and/or any suitable means of representing an identity of the prospective rider 10a. The vehicle management system 65 can receive the first identity indicator 59a when the prospective rider 10a is at least 500 feet away from the vehicle 2 (e.g., prior to the vehicle 2 pulling over to pick up the rider). The vehicle management system 65 can receive the first identity indicator 59a prior to the vehicle 2 detecting the second identity indicator 59b of the person 10b.

In some embodiments, methods include receiving, by the vehicle management system 65, a first identity indicator 59a of the prospective rider 10a in response to the prospective rider 10a requesting a ride from a ride providing service with many vehicles. The prospective rider 10a can request the ride with or without knowing which specific vehicle 2 will provide the ride. Then, methods can include detecting, by the vehicle 2, the second identity indicator 59b of the person 10b once the vehicle 2 that will provide that ride is within a direct detection range 68 of the person 10b.

In some embodiments, the person 10b is detected by detecting an electronic device (e.g., the remote computing device 3f) in the possession of the person 10b. The identity of the prospective rider 10a can be checked when the prospective rider 10a requests the ride. The identity of the person 10b can be checked as the vehicle 2 approaches the person 10b to provide the ride, when the vehicle 2 is within a direct detection range 68 of the person 10b, as the person 10b attempts to enter the vehicle 2, when the person 10b is inside the vehicle 2 prior to starting to provide the ride, and/or when the person 10b is inside the vehicle 2 during the ride (e.g., as the vehicle 2 is moving towards the destination of the person 10b).

In several embodiments, the vehicle 2 can detect the second identity indicator 59b of the person 10b in response to the prospective rider 10a requesting a ride. For example, requesting the ride can start a chain of events that results in a vehicle 2 being sent (e.g., by the vehicle management system 65, by a management system) to the rider. Then, the vehicle 2 can detect the second identity indicator 59b of the person 10b.

Some embodiments comprise determining, by the vehicle management system 65, that the first and second identity indicators are indicative of the person 10b being the prospective rider 10a. For example, the first identity indicator 59a can be a name associated with a user account 69. The second identity indicator 59b can be data (e.g., a code) send from a remote computing device 3f (e.g., a computer, a smartphone) of the person 10b to the vehicle 2. The system can determine if the data is also associated with the same user account 69. In some embodiments, the first identity indicator 59a and the second identity indicator 59b match. In several embodiments, the first identity indicator 59a and the second identity indicator 59b are different, but are both associated with the prospective rider 10a such that by detecting the second identity indicator 59b, the system 65 knows that the person 10b is the prospective rider 10a (or at least is a person associated with the user account 69 of the prospective rider 10a). In some embodiments, the first identity indicator 59a is a first code (e.g., “121212”) that can be transmitted wirelessly from the remote computing device 3e of the prospective rider 10a to the vehicle management system 65 (e.g., via communication systems 5 and/or via computing systems 7 located remotely relative to the vehicle 2). The second identity indicator 59b can be a second code (e.g., “343434”) that can be transmitted wirelessly (from the remote computing device 3f of the person 10b waiting for a ride) to the vehicle 2 and/or to the vehicle management system 65. The vehicle management system 65 (e.g., a portion of the vehicle 2 and/or a computer system located remotely relative to the vehicle 2) can then determine if the first code (e.g., “121212”) and the second code (e.g., “343434”) are indicative of the person 10b being the prospective rider 10a. For example, in some embodiments, if the first and second codes are both associated with the user account 69 of the prospective rider 10a, then the system can determine that the first and second codes are indicative of the person 10b being the prospective rider 10a (or at least being authorized to receive a ride that is billed to the user account 69 of the prospective rider 10a).

The vehicle 2 can provide a ride to the person 10b in response to the vehicle management system 65 and/or the vehicle 2 determining that the first and second codes are indicative of the person 10b having permission from the prospective rider 10a to receive a ride (e.g., that is billed to the user account 69 of the prospective rider 10a).

In response to determining that the first and second codes are indicative of the person 10b having permission from the prospective rider 10a to receive a ride (e.g., that is billed to the user account 69 of the prospective rider 10a), the system can bill the user account 69 of the prospective rider 10a for the ride (e.g., even though the person 10b, not the prospective rider 10a, receives the ride). The amount billed for the ride can include a tip.

In some embodiments, multiple prospective riders 10a are associated with a single user account 69. Any of the prospective riders 10a can request a ride via the vehicle management system 65. In several embodiments, a prospective rider 10a (e.g., a parent) requests a ride for a different person 10b (e.g., a spouse or child of the parent).

In several embodiments, a prospective rider 10a requests a ride from the vehicle management system 65 for herself and additional people. The ride can be billed to the prospective rider 10a even though the ride provides also transportation to the additional people.

In some embodiments, the prospective rider 10a requests the ride, but the cost of the ride is divided among multiple riders. For example, if there are four riders, the prospective rider 10a might only be billed for 25% of the full cost of the ride.

The first identity indicator 59a and the second identity indicator 59b can be different types of identity indicators. The first identity indicator 59a and the second identity indicator 59b can be any of the identity indicators described herein and/or incorporated by reference.

In some embodiments, the first identity indicator 59a is a first picture and/or a username (e.g., of the prospective rider 10a) that can be transmitted wirelessly from the remote computing device 3e of the prospective rider 10a to the vehicle management system 65 (e.g., via communication systems 5 and/or via computing systems 7 located remotely relative to the vehicle 2). The second identity indicator 59b can be a second code (e.g., “343434”) that can be transmitted wirelessly (from the remote computing device 3f of the person 10b waiting for a ride) to the vehicle 2 and/or to the vehicle management system 65. The vehicle management system 65 can use the first picture and/or username to identify the prospective rider 10a. The vehicle management system 65 can use the second code to determine if the person 10b waiting for the ride is the correct person (e.g., 10a) for the vehicle 2 to pick up and to provide a ride. For example, the vehicle management system 65 can receive the second code and then can determine if the second code is associated with the user account 69 and/or is associated with a person who has the permission of the prospective rider 10a to receive a ride that is billed to the user account 69.

Several embodiments comprise providing, by the vehicle 2, a ride to the person 10b, and, in response to the determining, billing a user account 69 of the prospective rider 10a for the ride (e.g., as indicated by arrow 75). The vehicle management system 65 can send financial charge data 67 to the user account 69, which can be used to determine the bill of the prospective rider 10a.

The user account 69 can have credit card information, PayPal information, online payment information, and/or other information configured to enable billing the prospective rider 10a for the ride (e.g., such that a company that operates, directs, and/or controls the vehicle 2 and/or the vehicle management system 65 receives payment for the ride). The user account 69 can comprise a name that represents the prospective rider 10a, a mailing address of the prospective rider 10a, an email address of the prospective rider 10a, a phone number of the prospective rider 10a, and/or any suitable information to help collect debts owed by the prospective rider 10a for rides associated with the user account 69.

In some embodiments, methods of using a self-driving vehicle 2 comprise receiving, by a vehicle management system 65, by a vehicle 2, by a combination of the vehicle management system 65 and the vehicle 2, a first identity indicator 59a of a prospective rider 10a. Embodiments can comprise detecting, by the vehicle management system 65, by the vehicle 2, by a combination of the vehicle management system 65 and the vehicle 2, a second identity indicator 59b of a person 10b. Embodiments can comprise sending, by the vehicle management system 65, by the vehicle 2, by a combination of the vehicle management system 65 and the vehicle 2, the second identity indicator 59b to the vehicle management system 65. Embodiments can comprise determining, by the vehicle management system 65, by the vehicle 2, by a combination of the vehicle management system 65 and the vehicle 2, that the first and second identity indicators are indicative of the person 10b being the prospective rider 10a. Embodiments can comprise, in response to the determining, billing, by the vehicle management system 65, by the vehicle 2, by a combination of the vehicle management system 65 and the vehicle 2, by a second system, a user account 69 of the prospective rider 10a for the ride.

Some embodiments comprise detecting the second identity indicator 59b while the person 10b is located within a direct detection range 68 of the vehicle 2. For example, the vehicle 2 can receive a wireless signal (e.g., via Bluetooth or another suitable short-range wireless communication protocol) from a remote computing device 3f of the person 10b. Rather than the wireless signal going from the remote computing device 3f to the vehicle 2 via a cellular network comprising antenna towers and other remote communication hardware, the wireless signal can go directly from the remote computing device 3f to the vehicle 2 (e.g., to an antenna of the vehicle 2). The direct detection range 68 of a camera 26 (shown in FIG. 2) of the vehicle 2 can be such that the camera 26 is able to take a picture of the person 10b. The direct detection range of a fingerprint scanner can be such that the scanner is able to scan the fingerprint of the person 10b.

Several embodiments comprise receiving the first identity indicator 59a in response to the vehicle 2 detecting the second identity indicator 59b. For example, the vehicle management system 65 can receive the first identity indicator 59a after the vehicle 2 has received the second identity indicator 59b. Once the vehicle 2 has received the second identity indicator 59b, the vehicle 2 can request the first identity indicator 59a to enable the vehicle 2 to bill the appropriate user account 69.

Several embodiments comprise receiving the first identity indicator 59a while the person 10b is located outside of the direct detection range 68 (e.g., prior to the vehicle 2 approaching the person 10b and/or arriving at a pickup location).

In some embodiments, the second identity indicator 59b is identification data. Identification data can be received indirectly by the vehicle 2 from a remote computing device 3f. For example, the wireless communication that comprises the identification data can travel from the remote computing device 3f via cellular networks and/or the Internet to the vehicle 2. Identification data can be received via a direct wireless communication from a remote computing device 3f to the vehicle 2 (e.g., via Bluetooth or another short-range wireless communication protocol). Detecting the second identity indicator 59b can comprise receiving, by the vehicle 2, the identification data from a remote computing device 3f of the person 10b via a direct wireless communication from the remote computing device 3f to the vehicle 2.

In several embodiments, the first identity indicator 59a is identification data from a remote computing device 3e of the prospective rider 10a. For example, when the prospective rider 10a creates her user account 69 and/or requests a ride via an app, the remote computing device 3e can capture identification data and/or a remote system can create identification data that is then associated with the remote computing device 3e (to enable the system to recognize who is requesting a ride). Some embodiments comprise receiving, by the vehicle management system 65, the first identity indicator 59a via an indirect wireless communication.

In some embodiments, the second identity indicator 59b comprises a passcode entered by the person 10b while the person 10b is located within a direct detection range 68 of the vehicle 2. The vehicle can detect the passcode, which the person 10b can enter via a touch screen 35 of the vehicle 2. The person 10b can also enter the passcode via a touch screen of the remote computing device 3f. The remote computing device 3f can then send the passcode (or data based on the passcode) to the vehicle management system 65.

In several embodiments, the second identity indicator 59b comprises a picture of the person 10b. Detecting the second identity indicator 59b can comprise using a camera 26 of the vehicle 2 to take the picture. The picture can be a video, a still picture, an infrared picture, and/or any visual representation of the person 10b.

In some embodiments, the second identity indicator 59b comprises a fingerprint of the person 10b. Methods can comprise detecting, by the vehicle 2, the fingerprint. Methods can comprise receiving, by the vehicle 2, the fingerprint (e.g., via a fingerprint scanner of the vehicle 2 or of a remote computing device 3f).

In several embodiments, the second identity indicator 59b comprises a sound emitted by the person 10b. The sound can be words spoken by the person 10b. Methods can comprise detecting, by the vehicle 2, the sound. A microphone system 27 of the vehicle 2 can detect the sound.

In some embodiments, the second identity indicator 59b comprises a physical trait of the person 10b. Methods can comprise detecting, by a biometric device 36 of the vehicle 2, the physical trait. The biometric device 36 is illustrated in FIG. 2. In some embodiments, the biometric device 36 is a fingerprint scanner.

A biometric device is a security identification and authentication device. Biometric devices can use automated methods of verifying and/or recognizing the identity of a person 10b based on at least one physiological or behavioral characteristic. These characteristics can include fingerprints, finger dimensions, facial images, body shape recognition, iris prints, and voice recognition. Embodiments can use chemical biometric devices. Chemical biometric devices can analyze DNA, blood, sweat, and other chemical markers to grant access to users.

Embodiments can use visual biometric devices, which can analyze visual features of humans to grant ride permission. Visual biometric device can comprise iris recognition, retina recognition, face recognition, body recognition, and finger recognition. Embodiments can comprise behavioral biometric devices, which can analyze how the person walks, moves, sits, and stands to verify that a person is associated with a particular user account.

Embodiments can also use olfactory biometric devices (e.g., to analyze body odor to distinguish between different people). Embodiments can also comprise auditory biometric devices (e.g., to analyze a speaker's voice and word choices to determine the identity of a speaker).

Several embodiments comprise authorizing, by the vehicle management system 65 and/or by the vehicle 2, the vehicle 2 to provide a ride to the person 10b in response to determining that the first identity indicator 59a and the second identity indicator 59b are indicative of the person 10b being the prospective rider 10a. The determining can occur while the person 10b is at least one of waiting for the ride and located in the vehicle 2. Receiving the first identity indicator 59a can occur prior to detecting the second identity indicator 59b. Receiving the first identity indicator 59a can occur prior to the prospective rider 10a requesting a ride and/or prior to the person 10b waiting for the ride.

In some embodiments, at least a portion of the vehicle management system 65 is located in the vehicle 2. In several embodiments, at least a portion of the vehicle management system 65 is located remotely relative to the vehicle 2. The vehicle management system 65 can comprise many servers, computers, and vehicles 2. The vehicle management system 65 can comprise cloud computing and cloud storage.

In several embodiments, the entire vehicle management system 65 is located in the vehicle 2. The vehicle 2 can comprise the vehicle management system 65.

In some embodiments, a first portion of the vehicle management system 65 is physically coupled to the vehicle 2, and a second portion of the vehicle management system 65 is not physically coupled to the vehicle 2. The second portion can be located remotely relative to the vehicle 2. In several embodiments, the entire vehicle management system 65 is located remotely relative to the vehicle 2.

In several embodiments, the vehicle management system 65 is located remotely relative to the vehicle 2. Methods can comprise sending, by the vehicle 2, a wireless communication having the second identity indicator 59b, to the vehicle management system 65 (e.g., as indicated by arrow 74), and/or receiving, by the vehicle 2 from the vehicle management system 65, authorization for the vehicle 2 to provide a ride to the person 10b in response to the sending and/or determining that the first identity indicator 59a and the second identity indicator 59b are indicative of the person 10b being the prospective rider 10a.

In some embodiments, the vehicle management system 65 is physically coupled to the vehicle 2 such that the vehicle 2 is configured to transport the vehicle management system 65.

FIG. 6 illustrates a human representative 20 of the vehicle 2. The human representative 20 is located remotely relative to the vehicle 2. Some issues can be resolved with the help of the human representative 20. The human representative can use a remote computing device 3g to communicate with the vehicle 2. The remote computing device 3g can be a computer.

Several embodiments comprise automatically starting a call with a human representative 20 of the vehicle 2 and/or of the vehicle management system 65 in response to the person 10b entering the vehicle 2. The call can be configured to solicit information that the vehicle 2 and/or the system 65 needs from the person 10b. The call can be configured to provide instructions to the person 10b. For example, the call can be configured to instruct the person 10b to exit the vehicle 2 because the person 10b is not the prospective rider 10a.

In some embodiments, the vehicle 2 comprises a speaker 32 and a microphone system 27 configured to enable two-way audio communication. Methods can comprise initiating, enabling, starting, facilitating, and/or prompting, in response to the person 10b entering the vehicle 2, the two-way audio communication between the person 10b and a human representative 20 of the vehicle 2 while the human representative 20 is located remotely relative to the vehicle 2. The human representative 20 can be an owner of the vehicle 2. The human representative 20 can be an employee or contractor at a company hired to help manage rides provided by the vehicle 2, which might or might not be owned by the company.

Several embodiments comprise initiating, enabling, starting, facilitating, and/or prompting a two-way audio communication between the person 10b and a human representative 20 of the vehicle 2 while the human representative 20 is located remotely relative to the person 10b and the vehicle 2 in response to detecting, by the vehicle 2, at least one of the vehicle 2 moving within a proximity range of the person 10b, the person 10b approaching the vehicle 2, the person 10b entering the vehicle 2, and the person 10b being located in the vehicle 2. The proximity range can be a detection range 68 of the vehicle 2 and/or a predetermined distance. In several embodiments, the proximity range is 30 feet.

In alternative embodiments, any step performed by the vehicle management system 65 can be performed by the vehicle 2. In alternative embodiments, any step performed by the vehicle 2 can be performed by the vehicle management system 65. The vehicle management system 65 can be a part of the vehicle 2, can have a portion that is part of the vehicle 2, can have a portion that is not part of the vehicle 2, and/or can be physically completely separate from the vehicle 2. The vehicle management system 65 can be communicatively coupled to the vehicle 2. The vehicle management system 65 can communicate with the vehicle 2 via wires and/or wirelessly.

In some cases, a prospective rider 10a requests a ride, but the vehicle 2 accidentally picks up the wrong person 10c. As a result, the prospective rider 10a might not receive the ride from the vehicle 2. The prospective rider 10a will want to ensure she is not billed for a ride given to someone 10c not associated with her user account 69. In some embodiments, a user account 69 is associated with multiple people (e.g., a mother and her teenage child). The mother likely would not mind if she is billed for a ride given to her child. The mother, however, will not want to be billed for a ride accidentally given to a stranger 10c.

Some embodiments comprise determining, by the vehicle management system 65, that the first identity indicator 59a and the second identity indicator 59b are not indicative of the person 10c being the prospective rider 10a. Methods can comprise initiating and/or prompting (in response to the determining) a two-way audio communication between the person 10c and a human representative 20 of the vehicle 2 while the human representative 20 is located remotely relative to the person 10c and the vehicle 2. The human representative 20 can be a manager of the vehicle 2, an owner of the vehicle 2, the prospective rider 10a, and/or any suitable person.

Several embodiments comprise determining, by the vehicle management system 65, that the first identity indicator 59a and the second identity indicator 59b are not indicative of the person 10c being the prospective rider 10a, and instructing, in response to the determining, the person 10c to exit the vehicle 2. The instructing can be via a sound emitted by a speaker 32 of the vehicle 2 and/or by a speaker of a remote computing device of the person 10c. The sound can say, “You are not the intended rider. Please exit the vehicle.”

Some embodiments comprise determining, by the vehicle management system 65, that the first identity indicator 59a and the second identity indicator 59b are not indicative of the person 10c being the prospective rider 10a; providing, by the vehicle 2, a ride to the person 10c; and/or prompting, in response to the determining, another vehicle 2 to pick up the prospective rider 10a, 10b. The prompting can be while the rider 10c is located inside the vehicle 2. Even though the prospective rider 10a, 10b might not receive a ride from the intended vehicle 2, at least the person 10c will receive a ride and the prospective rider 10a, 10b will eventually receive a ride (e.g., from a different vehicle 2 or from the original vehicle 2 once the vehicle 2 has finished providing the ride to the person 10c).

In some embodiments, a remote computing device helps authenticate the identity of the person who has possession (e.g., is holding) the remote computing device. A method of using a self-driving vehicle 2 can comprise receiving, by a vehicle management system 65, a first identity indicator 59a of a first remote computing device 3e of a prospective rider 10a. The first identity indicator 59a is associated with a user account 69. The vehicle management system 65 can receive the identity indicator 59a in response to the prospective rider 10a asking the system 65 for a ride.

Methods can comprise wirelessly detecting, by the vehicle 2 at least partially in response to the prospective rider 10a requesting a ride, a second identity indicator 59b of a second remote computing device 3f of a person 10b. The vehicle 2 can receive a wireless communication having the second identity indicator 59b directly from the second remote computing device 3f as the person 10b is waiting for the ride (e.g., as the person is waiting at the pickup location).

The prospective rider 10a asked for a ride, so the vehicle 2 goes to the location of the person 10b to detect the second identity indicator 59b. Methods can comprise sending, by the vehicle 2, the second identity indicator 59b to the vehicle management system 65; and/or determining, by the vehicle management system 65, that the second identity indicator 59b is indicative of being associated with the user account 69. Thus, the system 65 can be sure to bill the correct user account 69 for the ride.

Several embodiments comprise providing, by the vehicle 2, the ride to the person 10b (before, while, and/or after) determining that the second identity indicator 59b is indicative of being associated with the user account 69. Some methods comprise billing the user account 69 of the prospective rider 10a for the ride in response to determining that the second identity indicator 59b is indicative of being associated with the user account 69. The first remote computing device 3e and the second remote computing device 3f can be a single smartphone or can be different smartphones. The remote computing devices can be desktop computers.

In some embodiments, the first identity indicator 59a is a first identification code configured to be transmitted wirelessly. The second identity indicator 59b can be a second identification code configured to be transmitted wirelessly. Detecting the second identity indicator 59b can comprise receiving, by the vehicle 2, the second identification code via a direct wireless communication from the second remote computing device 3f. The identification codes can be generated in response to the prospective rider requesting a ride via an app running on a smartphone.

In several embodiments, detecting the second identity indicator 59b occurs while the second remote computing device 3f is located within a direct detection range 68 of the vehicle 2. Receiving the first identity indicator 59a can occur in response to detecting the second identity indicator 59b and/or in response to detecting the person 10b waiting for a ride. Receiving the first identity indicator 59a can occur while the person 10b is located outside of the direct detection range 68.

Some embodiments comprise a system having a vehicle management system 65 configured to receive a first identity indicator 59a of a prospective rider 10a requesting a ride; a user account 69 configured to enable billing the prospective rider 10a for the ride, wherein the vehicle management system 65 is configured to send ride expense information to the user account 69; and/or a vehicle 2 communicatively coupled to the vehicle management system 65, wherein the vehicle 2 is configured to detect a second identity indicator 59b of a person 10b waiting for the ride. The vehicle management system 65 can be configured to determine that the first and second identity indicators are indicative of the person 10b having permission from the prospective rider 10a to receive the ride and bill the ride to the user account 69 of the prospective rider 10a. The prospective rider 10a can provide permission in many ways, including far in advance of the ride or as the person 10b is waiting for the ride. In some embodiments, the prospective rider 10a provides permission for the person 10b to receive rides that billed to the user account 69 of the prospective rider 10a when the prospective rider 10a “adds” the person 10b to the user account 69.

Several embodiments comprise a first wireless communication (e.g., 71) from a first remote computing device 3e of the prospective rider 10a to the vehicle management system 65. The first wireless communication can be configured to request the ride and/or can be configured to send a pickup location 78 of the ride to the vehicle management system 65. The vehicle management system 65 can be configured to prompt the vehicle 2 to go to the pickup location 78 to provide the ride in response to receiving the first wireless communication.

Some embodiments comprise a second wireless communication (e.g., 73) from a second remote computing device 3f (of the person 10b waiting for the ride) to the vehicle 2. The second wireless communication can comprise the second identity indicator 59b. The vehicle 2 can comprise an antenna 77 configured to receive the second wireless communication.

### INTERPRETATION

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section. Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

1. A method of using a self-driving vehicle when the vehicle picks up a person other than a prospective rider who requested a ride, the method comprising:
receiving, by a vehicle management system, a first identity indicator of the prospective rider;
detecting, by a sensor of the vehicle, a second identity indicator of the person;
sending, by the vehicle, the second identity indicator to the vehicle management system;
determining, by the vehicle management system, that the first and second identity indicators are not indicative of the person being the prospective rider;
providing, by the vehicle, the ride to the person rather than to the prospective rider who requested the ride; and
prompting, in response to the determining, another vehicle to pick up the prospective rider.

2. The method of claim 20, further comprising determining, by the vehicle management system, that the first and second identity indicators are indicative of the person being the prospective rider.

3. The method of claim 1, further comprising, in response to the determining, billing a user account of the person for the ride.

4. The method of claim 1, wherein the detecting occurs while the person is located within a direct detection range of the vehicle.

5. The method of claim 4, wherein the receiving occurs at least one of in response to the detecting and while the person is located outside of the direct detection range.

6. The method of claim 1, wherein the second identity indicator is identification data, and the detecting comprises receiving, by the vehicle, the identification data from a remote computing device of the person via a direct wireless communication from the remote computing device to the vehicle.

7. The method of claim 6, further comprising receiving, by the vehicle management system, the first identity indicator via an indirect wireless communication.

8. The method of claim 3, wherein the second identity indicator comprises a passcode entered by the person while the person is located within a direct detection range of the vehicle.

9. The method of claim 3, wherein the second identity indicator comprises a picture of the person, wherein the detecting comprises taking, by a camera of the vehicle, the picture.

10. The method of claim 3, wherein the second identity indicator comprises a fingerprint of the person, wherein the method comprises detecting, by the vehicle, the fingerprint.

11. The method of claim 3, wherein the second identity indicator comprises a sound emitted by the person, wherein the method comprises detecting, by the vehicle, the sound.

12. The method of claim 1, wherein the second identity indicator comprises a physical trait of the person, the method further comprising detecting, by a biometric device of the vehicle, the physical trait.

13. The method of claim 1, further comprising authorizing, by the vehicle management system, the vehicle to provide the ride to the person in response to the determining.

14. The method of claim 1, wherein the determining occurs while the person is at least one of waiting for the ride and located in the vehicle.

15. The method of claim 14, wherein the receiving occurs prior to the detecting.

16. The method of claim 14, wherein the receiving occurs prior to the person waiting for the ride.

17. The method of claim 1, wherein the vehicle management system is located remotely relative to the vehicle, the method further comprising sending, by the vehicle, a wireless communication having the second identity indicator, to the vehicle management system, and receiving, by the vehicle, authorization for the vehicle to provide the ride to the person in response to the sending and the determining.

18. The method of claim 2, wherein the vehicle management system is physically coupled to the vehicle such that the vehicle is configured to transport the vehicle management system.

19. The method of claim 1, wherein the vehicle comprises a speaker and a microphone system configured to enable two-way audio communication, the method further comprising initiating, in response to the determining, the two-way audio communication between the person and a human representative of the vehicle while the human representative is located remotely relative to the vehicle.

20. A method of using a self-driving vehicle having a speaker and a microphone system configured to enable two-way audio communication, the method comprising:
receiving, by a vehicle management system, a first identity indicator of a prospective rider;
detecting wirelessly, by a sensor of the vehicle, a second identity indicator of a person;
sending, by the vehicle, the second identity indicator to the vehicle management system; and
initiating the two-way audio communication between the person and a human representative of the vehicle while the human representative is located remotely relative to the person and the vehicle, wherein the two-way audio communication is automatically initiated in response to detecting, by the vehicle, at least one of the vehicle moving within a proximity range of the person, the person approaching the vehicle, and the person entering the vehicle.

21. The method of claim 1, further comprising determining, by the vehicle management system, that the first and second identity indicators are not indicative of the person being the prospective rider, and initiating, in response to the determining, a two-way audio communication between the person and a human representative of the vehicle while the human representative is located remotely relative to the person and the vehicle.

22. The method of claim 1, further comprising determining, by the vehicle management system, that the first and second identity indicators are not indicative of the person being the prospective rider, and instructing, in response to the determining, the person to exit the vehicle.

23. (canceled)

24. A method of determining a prospective rider is authorized to receive a ride from a self-driving vehicle by verifying an identity of a remote computing device, the method comprising:
receiving, by a vehicle management system while the prospective rider is located outside of a direct detection range of the vehicle, a first identity data of the remote computing device of the prospective rider, wherein the first identity data is associated with a user account;
detecting wirelessly, by a sensor of the vehicle, a second identity data of the remote computing device while the remote computing device is located within the direct detection range of the vehicle; and
determining, by the vehicle management system, that the prospective rider is authorized to receive the ride from the vehicle by determining that the second identity data of the remote computing device is associated with the user account.

25. (canceled)

26. (canceled)

27. The method of claim 24, wherein the first identity data is a first identification code transmitted wirelessly via at least one remotely located intermediary communication system and the second identity data is a second identification code transmitted wirelessly from the remote computing device to an antenna of the vehicle, wherein the detecting comprises receiving, by the vehicle, the second identification code via a direct wireless communication from the remote computing device.

28. The method of claim 31, wherein the receiving occurs via at least one remotely located intermediary communication system, and the detecting occurs while the second remote computing device is located within a direct detection range of the antenna of the vehicle.

29. The method of claim 28, wherein the receiving occurs in response to the detecting.

30. The method of claim 28, wherein the receiving occurs while the person is located outside of the direct detection range.

31. A method of using a self-driving vehicle to pick up a prospective rider at a pickup location, the method comprising:
receiving remotely, by a vehicle management system, a first identity data of a first remote computing device of the prospective rider;
moving the vehicle to the pickup location;
detecting directly and wirelessly, by an antenna of the vehicle, at least partially in response to the prospective rider requesting a ride, a second identity data of a second remote computing device of a person located at the pickup location; and
determining, by the vehicle management system, that the first identity data of the first remote computing device and the second identity data of the second remote computing device are indicative of the person being the prospective rider.

32. The method of claim 31, further comprising authorizing the person to receive the ride from the vehicle in response to determining that the first remote computing device is the second remote computing device.

33. The method of claim 31, further comprising sending, by the vehicle, a wireless communication having the second identity data, to the vehicle management system, and receiving, by the vehicle, authorization for the vehicle to provide the ride to the person in response to the sending and the determining.

34. The method of claim 31, wherein the determining occurs while the person is at least one of waiting for the ride and located in the vehicle.

35. The method of claim 31, wherein the vehicle comprises a speaker and a microphone system configured to enable two-way audio communication, the method further comprising initiating the two-way audio communication between the person and a human representative of the vehicle while the human representative is located remotely relative to the person and the vehicle, wherein the two-way audio communication is automatically initiated in response to detecting, by the vehicle, at least one of the vehicle moving within a proximity range of the person, the person approaching the vehicle, and the person entering the vehicle.

36. The method of claim 1, wherein the first identity indicator is associated with a user account of the prospective rider, wherein determining, by the vehicle management system, that the first and second identity indicators are not indicative of the person being the prospective rider comprises determining that the second identify indicator is not associated with the user account of the prospective rider.
